(19) United States
(12) Patent Application Publication
(10) Pub. No.: US 2024/0085815 A1
(43) Pub. Date: Mar. 14, 2024

(54) ELECTROSTATIC IMAGE DEVELOPING TONER, ELECTROSTATIC IMAGE DEVELOPER, TONER CARTRIDGE, PROCESS CARTRIDGE, IMAGE FORMING APPARATUS, AND IMAGE FORMING METHOD

(71) Applicant: FUJIFILM BUSINESS INNOVATION CORP., TOKYO (JP)

(72) Inventors: Shinya SAKAMOTO, Kanagawa (JP); Masaki IWASE, Kanagawa (JP); Yumi TANAKA, Kanagawa (JP)

(73) Assignee: FUJIFILM BUSINESS INNOVATION CORP., TOKYO (JP)

(21) Appl. No.: 18/509,555

(22) Filed: Nov. 15, 2023

Related U.S. Application Data
(63) Continuation of application No. PCT/JP2022/035776, filed on Sep. 26, 2022.

(30) Foreign Application Priority Data
Sep. 27, 2021 (JP) 2021-157169
Sep. 13, 2022 (JP) 2022-145659

(51) Int. Cl. G03G 9/087; G03G 9/08; G03G 15/08

(52) U.S. Cl. CPC G03G 9/08711; G03G 9/0819; G03G 9/08755; G03G 9/08793; G03G 15/08

(57) ABSTRACT

An electrostatic image developing toner includes toner particles including a binder resin. When loss tangents tan δ at a temperature of 90° C. and a strain of 1%, a temperature of 90° C. and a strain of 50%, a temperature of 150° C. and a strain of 1%, and a temperature of 150° C. and a strain of 50%, the loss tangents tan δ being determined by measurement of dynamic viscoelasticity of the electrostatic image developing toner, are defined as D1(90), D50(90), D1(150), and D50(150), respectively, D1(90), D50(90), D1(150), and D50(150) are each 0.5 or more and 2.5 or less, D50(150)−D1(150) is less than 1.5, and D50(90)−D1(90) is less than 1.0; the toner particles further include resin particles; and the number average molecular weight of a component of the toner particles, the component being soluble in tetrahydrofuran, is 5000 or more and 15000 or less.

### CROSS-REFERENCE TO RELATED APPLICATIONS

This is a continuation of International Publication No. PCT/JP2022/035776 filed on Sep. 26, 2022, and claims priority from Japanese Patent Application No. 2021-157169 filed on Sep. 27, 2021, and Japanese Patent Application No. 2022-145659 filed on Sep. 13, 2022.

### BACKGROUND

### (i) Technical Field

The present disclosure relates to an electrostatic image developing toner, an electrostatic image developer, a toner cartridge, a process cartridge, an image forming apparatus, and an image forming method.

### (ii) Related Art

Japanese Unexamined Patent Application Publication No. 2020-042122 discloses an electrostatic latent image developing toner that includes toner particles including a binder resin. The binder resin includes an amorphous resin and a crystalline resin. When an integral of the stress in a stress-strain curve prepared at a strain amplitude of 100% in the measurement of strain dispersion of dynamic viscoelasticity at a temperature of 130° C., a frequency of 1 Hz, and a strain amplitude of 1.0% to 500% is defined as S130 and the slope of the major axis of the stress-strain curve is defined as θ130, S130 is more than 0 Pa and 350000 Pa or less and θ130 is more than 22° and less than 90°.

Japanese Unexamined Patent Application Publication No. 2020-106685 discloses an electrostatic image developing toner that includes at least a binder resin and a release agent. The binder resin includes at least a crystalline resin. The storage modulus of the toner which is measured at a frequency of 1 Hz and 150° C. while a strain is changed from 0.01% to 1000% satisfies specific relationships.

Japanese Unexamined Patent Application Publication No. 2020-042121 discloses an electrostatic latent image developing toner that includes toner particles including a binder resin. The binder resin includes an amorphous vinyl resin and a crystalline resin. When an integral of the stress in a stress-strain curve prepared at a strain amplitude of 100% in the measurement of strain dispersion of dynamic viscoelasticity at a temperature of 130° C., a frequency of 1 Hz, and a strain amplitude of 1.0% to 500% is defined as S130 and the slope of the major axis of the stress-strain curve is defined as θ130, S130 is more than 0 Pa and 350000 Pa or less and θ130 is 0° or more and less than 10°.

Japanese Unexamined Patent Application Publication No. 2019-144368 discloses an electrostatic image developing toner that includes toner matrix particles including at least a binder resin and a release agent and an external additive. The binder resin includes at least a crystalline resin. The peak top value tan δ6° C./min of the loss tangent of the electrostatic image developing toner which is measured at a frequency of 1 Hz and a heating rate of 6° C./min while the temperature is changed from 25° C. to 100° C. and the peak top value tan δ3° C./min of the loss tangent of the electrostatic image developing toner which is measured at a frequency of 1 Hz and a heating rate of 3° C./min while the temperature is changed from 25° C. to 100° C. satisfy specific relationships.

Japanese Unexamined Patent Application Publication No. 2013-160886 discloses an electrostatic image developing toner that includes at least a binder resin, a colorant, and a release agent. The change γG′ in the storage modulus G′ of the toner satisfies 50%<γG′<86%. The change γG″ in the loss modulus G″ of the toner is more than 50%. The storage modulus G′ of the toner at a temperature of 150° C. and a strain of 1% to 50% is 5×10 2 to 3.5×10³ Pa·s. The binder resin includes an amorphous resin and a crystalline resin.

Japanese Unexamined Patent Application Publication Nos. 2011-237793 and 2011-237792 disclose an electrostatic image developing toner composed of toner particles including a binder resin. In an elasticity image of a cross section of the toner particles which is taken with an atomic force microscope (AFM), the binder resin has a domain-matrix structure consisting of a high-elasticity resin constituting a domain and a low-elasticity resin constituting a matrix. The arithmetic average of the ratios (L/W) of the major-axis lengths L to the minor-axis lengths W of the domains falls within the range of 1.5 to 5.0. The proportion of domains having a major-axis length L of 60 to 500 nm is 80 number % or more. The proportion of domains having a minor-axis length W of 45 to 100 nm is 80 number % or more.

### SUMMARY

In the formation of images using an electrostatic image developing toner, for example, a toner image transferred on a recording medium is fixed to the recording medium by heat and pressure. In the case where an electrostatic image developing toner including toner particles that can be easily melted by heat is used to achieve suitable fixability, the difference between the glossiness of an image fixed under a high-temperature, high-pressure condition and the glossiness of an image fixed under a low-temperature, low-pressure condition may be increased.

Aspects of non-limiting embodiments of the present disclosure relate to an electrostatic image developing toner that enables suitable fixability to be achieved and reduces the difference in glossiness between an image fixed under a high-temperature, high-pressure condition and an image fixed under a low-temperature, low-pressure condition, compared with the case where any of D1(90), D50(90), D1(150), and D50(150) is less than 0.5 or more than 2.5, D50(150)−D1(150) is 1.5 or more, or D50(90)−D1(90) is 1.0 or more, the case where the toner particles do not include resin particles, or the case where the number average molecular weight of a tetrahydrofuran-soluble component of the toner particles is less than 5000 or more than 15000.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic image developing toner including toner particles including a binder resin, wherein, when loss tangents tan δ at a temperature of 90° C. and a strain of 1%, a temperature of 90° C. and a strain of 50%, a temperature of 150° C. and a strain of 1%, and a temperature of 150° C. and a strain of 50%, the loss tangents tan δ being determined by measurement of dynamic viscoelasticity of the electrostatic image developing toner, are defined as D1(90), D50(90), D1(150), and D50(150), respectively,
D1(90), D50(90), D1(150), and D50(150) are each 0.5 or more and 2.5 or less,
D50(150)−D1(150) is less than 1.5, and
D50(90)−D1(90) is less than 1.0;
the toner particles further include resin particles; and
a number average molecular weight of a component of the toner particles, the component being soluble in tetrahydrofuran, is 5000 or more and 15000 or less.

### BRIEF DESCRIPTION OF THE DRAWINGS

Exemplary embodiments of the present disclosure will be described in detail based on the following figures, wherein:

FIG. 1 is a schematic diagram illustrating an example of an image forming apparatus according to this exemplary embodiment; and

FIG. 2 is a schematic diagram illustrating an example of a process cartridge detachably attached to the image forming apparatus according to this exemplary embodiment.

### DETAILED DESCRIPTION

Exemplary embodiments of the present disclosure are described below. It should be noted that the following description and Examples are intended to be illustrative of the exemplary embodiments but not restrictive of the scope of the present disclosure.

In the specification, when numerical ranges are described in a stepwise manner, the upper or lower limit of a numerical range may be replaced with the upper or lower limit of another numerical range, respectively. In the specification, the upper and lower limits of a numerical range may be replaced with the upper and lower limits described in Examples below.

In the specification, the term “(meth)acryl” refers to both acryl and methacryl.

In the specification, the term “step” refers not only to an individual step but also to a step that is not distinguishable from other steps but achieves the intended purpose of the step.

Each of the components may include a plurality of substances.

In the case where a composition includes a plurality of types of substances that correspond to a component of the composition, the content of the component in the composition is the total content of the substances in the composition unless otherwise specified.

Electrostatic Image Developing Toner

An electrostatic image developing toner according to this exemplary embodiment (hereinafter, also referred to as “toner”) is an electrostatic image developing toner comprising toner particles including a binder resin, wherein, when loss tangents tan δ at a temperature of 90° C. and a strain of 1%, a temperature of 90° C. and a strain of 50%, a temperature of 150° C. and a strain of 1%, and a temperature of 150° C. and a strain of 50%, the loss tangents tan δ being determined by measurement of dynamic viscoelasticity of the electrostatic image developing toner, are defined as D1(90), D50(90), D1(150), and D50(150), respectively, D1(90), D50(90), D1(150), and D50(150) are each 0.5 or more and 2.5 or less, D50(150)−D1(150) is less than 1.5, and D50(90)−D1(90) is less than 1.0; the toner particles further include resin particles; and the number average molecular weight of a component of the toner particles, the component being soluble in tetrahydrofuran, is 5000 or more and 15000 or less.

Hereinafter, the component soluble in tetrahydrofuran is also referred to as “THF soluble component”, and a toner such that D1(90), D50(90), D1(150), and D50(150) are each 0.5 or more and 2.5 or less, D50(150)−D1(150) is less than 1.5, and D50(90)−D1(90) is less than 1.0; the toner particles further include resin particles; and the number average molecular weight of the THF soluble component of the toner particles is 5000 or more and 15000 or less is also referred to as “specific toner”.

The toner according to this exemplary embodiment, which has the above-described structure, enables suitable fixability to be achieved and reduces the difference in glossiness between an image fixed under a high-temperature, high-pressure condition and an image fixed under a low-temperature, low-pressure condition. The reasons are presumably as follows. Hereinafter, the difference in glossiness between an image fixed under a high-temperature, high-pressure condition and an image fixed under a low-temperature, low-pressure condition is also referred to as “difference in glossiness by condition”.

As described above, an electrostatic image developing toner including toner particles that can be easily melted by heat may be used to achieve suitable fixability. In the case where images are formed using a toner including toner particles that can be easily melted by heat, the difference in glossiness by condition may be increased. This is presumably because the amount of deformation of the toner particles which occurs at a high temperature and a high strain is larger than the amount of deformation of the toner particles which occurs at a low temperature and a low strain.

A strain of 1% applied in the measurement of dynamic viscoelasticity means application of a displacement of 1% relative to the height (i.e., gap) of a sample. That is, a strain of 1% means application of a considerably small displacement and corresponds to the case where the pressure of the fuser applied in the toner fixing step is low. On the other hand, a strain of 50% corresponds to the case where the pressure of the fuser applied in the toner fixing step is high. A temperature of 90° C. and a strain of 1% corresponds to a low-temperature, low-pressure fixing condition, while a temperature of 150° C. and a strain of 50% corresponds to a high-temperature, high-pressure fixing condition. The loss tangents tan δ correspond to the amounts of deformation of the toner that occur under the respective fixing conditions. It is considered that controlling the difference between the loss tangent tan δ at a strain of 1% and the loss tangent tan δ at a strain of 50% to fall within a predetermined range enables the amount of deformation of the toner to be limited to fall within a predetermined range and reduces the difference in glossiness even in the case where the fixing pressure is changed.

The toner according to this exemplary embodiment is the specific toner. That is, D1(90), D50(90), D1(150), and D50(150) are all 0.5 or more and 2.5 or less, D50(150)−D1(150) is less than 1.5, and D50(90)−D1(90) is less than 1.0. Furthermore, the toner particles further include resin particles. Moreover, the number average molecular weight of the THF soluble component of the toner particles is 5000 or more and 15000 or less. The loss tangent of the specific toner does not vary greatly with a change in strain at 90° C. and 150° C. Since the toner has close viscoelasticity at a high temperature and a high strain and a low temperature and a low strain, it is considered that a fixed image having glossiness that does not vary greatly from the glossiness of an image fixed under a low-temperature, low-pressure condition can be formed even when the image is fixed under a high-temperature, high-pressure condition.

Since D1(90), D50(90), D1(150), and D50(150) are all 0.5 or more in this exemplary embodiment, the toner can be easily melted when being heated during fixing and suitable fixability may be achieved compared with the case where any of the above values is less than 0.5.

It is also considered that, since the toner particles include the resin particles, the amount of deformation caused by the pressure with which a toner fixed image is fused can be reduced and, consequently, a fixed image in which the difference in glossiness is small may be formed.

In addition, since the number average molecular weight of the THF soluble component of the toner particles is 5000 or more and 15000 or less, high fixability is achieved even when a high-viscoelasticity toner that has a loss tangent that does not greatly vary with a change in strain and is not easily deformed is used. Specifically, when the number average molecular weight of the THF soluble component falls within the above range, the likelihood of the toner particles becoming greatly deformed under a high-temperature, high-pressure fixing condition and the difference in glossiness being increased due to the presence of a large amount of low-molecular-weight components in the toner particles is reduced, compared with the case where the above number average molecular weight is excessively low. When the number average molecular weight of the THF soluble component falls within the above range, the deformation of the toner particles can be reduced due to the presence of a large amount of high-molecular-weight components in the toner particles compared with the case where the above number average molecular weight is excessively high. In addition, the possibility of low temperature fixability being difficult to be achieved is reduced. The number average molecular weight of the THF soluble component is further preferably 7000 or more and 10000 or less.

As described above, in this exemplary embodiment, it is considered that suitable fixability is achieved and the difference in glossiness between an image fixed under a high-temperature, high-pressure condition and an image fixed under a low-temperature, low-pressure condition is reduced.

The loss tangent of the toner is determined in the following manner.

Specifically, the toner that is to be analyzed is formed into a tablet form at normal temperature (25° C.) with a press forming machine to prepare a measurement sample. Using the measurement sample, dynamic viscoelasticity is measured with a rheometer under the following conditions. On the basis of the storage and loss modulus curves obtained, the loss tangents tan δ at temperatures of 90° C. and 150° C. and strains of 1% and 50% are determined as D1(90), D50(90), D1(150), and D50(150).

—Measurement Conditions—
Measuring equipment: Rheometer ARES-G2 (produced by TA Instruments, Inc.)
Measurement jig: 8-mm parallel plate
Gap: adjusted to 3 mm
Frequency: 1 Hz

The number average molecular weight of the THF soluble component in the toner particles is conducted using two columns of “HLC-8120GPC, SC-8020 (produced by Tosoh Corporation, 6.0 mmID×15 cm)” and tetrahydrofuran (THF) as an eluant after the THF soluble component of the toner particles has been prepared.

Specifically, the THF soluble component is prepared by dissolving 0.5 mg of the toner particles that are to be analyzed in 1 g of THF, subjecting the resulting liquid mixture to ultrasonic dispersion, and adjusting the concentration of the liquid mixture to 0.5% by mass.

The above measurement is conducted using an RI detector at a sample concentration of 0.5% by mass, a flow rate of 0.6 ml/min, a sample injection volume of 10 μl, and a measurement temperature of 40° C.

A calibration curve is prepared using 10 samples: “Polystyrene Standard Sample TSK Standard”: “A-500”, “F-1”, “F-10”, “F-80”, “F-380”, “A-2500”, “F-4”, “F-40”, “F-128”, and “F-700” produced by Tosoh Corporation.

In the case where toner particles are taken from a toner including an external additive, for example, the external additive is liberated from the toner by dispersing the toner in a 0.2-mass % aqueous solution of polyoxyethylene (10) octylphenyl ether at a concertation of 10% by mass and applying ultrasonic vibrations (frequency: 20 kHz, power: 30 W) to the resulting dispersion liquid for 60 minutes while the temperature is kept at 30° C. or less. The toner particles are separated from the dispersion liquid by filtering and subsequently cleaned in order to prepare toner particles from which the external additive has been removed.

The method for producing the specific toner is not limited.

Examples of the method for producing the specific toner include a method of adding resin particles having a storage modulus G′ of 1×10⁴ Pa or more and 1×10⁶ Pa or less at 90° C. or more and 150° C. or less in the measurement of dynamic viscoelasticity at a heating rate of 2° C./min to both region close to the surfaces of the toner particles and region close to the centers of the toner particles uniformly.

Hereinafter, resin particles having a storage modulus G′ of 1×10⁴ Pa or more and 1×10⁶ Pa or less at 90° C. or more and 150° C. or less are also referred to as “specific resin particles”.

The reasons for which the specific toner is likely to be produced when the specific resin particles are dispersed in both region close to the surfaces of the toner particles and region close to the centers of the toner particles uniformly are not clear but considered as follows.

As described above, the specific resin particles are particles having a storage modulus G′ of 1×10⁴ Pa or more even when the temperature is increased to 150° C. That is, the specific resin particles are particles having a high modulus of elasticity at high temperatures. Therefore, it is considered that, when toner particles include the specific resin particles, the loss tangent of the entire toner at a high temperature and a high strain is not likely to be increased, and the difference between the loss tangent of the entire toner at a high temperature and a high strain and the loss tangent of the entire toner at a low temperature and a low strain is reduced.

In particular, when the specific resin particles are dispersed in both region close to the surfaces of the toner particles and region close to the centers of the toner particles uniformly, the loss tangents of the toner at a low temperature and a low strain and a high temperature and a high strain are both reduced and the difference therebetween is also reduced. This presumably makes it easy to produce the specific toner.

In order to produce toner particles containing the specific resin particles, the affinity between the specific resin particles and the binder resin may be high. Specific examples of the method for enhancing the above affinity include a method of controlling the SP value and a method of using a surfactant as a dispersing agent for the specific resin particles. However, if specific resin particles having a high affinity for the binder resin are used, the specific resin particles are likely to mix with the binder resin and dispersibility may become degraded, since the specific resin particles are composed of organic polymers unlike a mineral filler, carbon black, metal particles, or the like.

On the other hand, if specific resin particles having a low affinity for the binder resin are used, the specific resin particles are not likely to be included inside the toner particles and may be ejected onto the surfaces of the toner particles or to the outside of the toner particles.

When specific resin particles having an intermediate affinity which exist between the specific resin particles having a high affinity for the binder resin and the specific resin particles having a low affinity for the binder resin are used, it is possible to produce toner particles that contain the specific resin particles to a certain extent. However, it is difficult to uniformly disperse the specific resin particles in the toner particles because, regardless of the toner production method used, such as emulsion aggregation or knead pulverization, when the specific resin particles are brought into contact with one another, they may be distributed unevenly while keeping being in contact with one another since they are made of the same material and have a high affinity for one another. It is considered that one of the reasons for which the specific resin particles keep being in contact with one another is that the polymer chains of a high-molecular-weight component constituting the specific resin particles are entangled with one another when being brought into contact with one another.

Accordingly, crosslinked resin particles are used as specific resin particles. This reduces the likelihood of the polymer chains to be entangled with one another and the likelihood of the specific resin particles keeping being in contact with one another and enables the specific resin particles to be arranged inside the toner particles uniformly.

The storage modulus G′ of the resin particles and the loss tangent tan δ and glass transition temperature Tg of the resin particles, which are described below, are determined in the following manner.

Specifically, a pressure is applied to the resin particles that are to be analyzed in order to prepare a disk-shaped sample having a thickness of 2 mm and a diameter of 8 mm, which is used as a measurement sample. In the case where resin particles included in the toner particles are to be analyzed, the measurement sample is prepared after the resin particles have been separated from the toner particles. For separating the resin particles from the toner particles, for example, the toner particles may be immersed in a solvent in which a binder resin is soluble and the resin particles are not soluble in order to dissolve the binder resin in the solvent and thereby obtain the resin particles.

The resulting disk-shaped sample, that is, a measurement sample, is sandwiched between parallel plates having a diameter of 8 mm. Dynamic viscoelasticity is measured under the following conditions, at a strain of 0.1% to 100% while the measurement temperature is increased from 10° C. to 150° C. at 2° C./min. The storage modulus G′ and loss tangent tan δ are determined on the basis of the storage modulus and loss modulus curves prepared in the above measurement. The peak temperature of the loss tangent tan δ is considered as a glass transition temperature Tg.

—Measurement Conditions—
Measuring equipment: Rheometer ARES-G2 (produced by TA Instruments, Inc.)
Gap: adjusted to 3 mm
Frequency: 1 Hz

Details of the toner according to this exemplary embodiment are described below.

The toner according to this exemplary embodiment includes toner particles and, as needed, an external additive.

Toner Particles

The toner particles include at least a binder resin and may include other components as needed.

As described above, the toner particles may further include the specific resin particles in order to produce the specific toner.

Toner particles including a binder resin and the specific resin particles are described below as an example of the toner particles included in the specific toner.

The toner particles include, for example, a binder resin and the specific resin particles and, as needed, a colorant, a release agent, and other additives.

Binder Resin

Examples of the binder resin include vinyl resins that are homopolymers of the following monomers or copolymers of two or more monomers selected from the following monomers: styrenes, such as styrene, para-chlorostyrene, and α-methylstyrene; (meth)acrylates, such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; ethylenically unsaturated nitriles, such as acrylonitrile and methacrylonitrile; vinyl ethers, such as vinyl methyl ether and vinyl isobutyl ether; vinyl ketones, such as vinyl methyl ketone, vinyl ethyl ketone, and vinyl isopropenyl ketone; and olefins, such as ethylene, propylene, and butadiene.

Examples of the binder resin further include non-vinyl resins, such as epoxy resins, polyester resins, polyurethane resins, polyamide resins, cellulose resins, polyether resins, and modified rosins; a mixture of the non-vinyl resin and the vinyl resin; and a graft polymer produced by polymerization of the vinyl monomer in the presence of the non-vinyl resin.

The above binder resins may be used alone or in combination of two or more.

The binder resin may include a polyester resin.

When the binder resin includes a polyester resin, in the case where styrene (meth)acrylic resin particles are used as specific resin particles, the difference between the solubility parameter SP (S) of the specific resin particles, which is described below, and the solubility parameter SP (R) of the binder resin (i.e., SP (S)−SP (R)) is likely to fall within the preferable numerical range. This makes it easy to disperse the specific resin particles in the toner particles and consequently reduces the difference in glossiness by condition.

When the difference (SP (S)−SP (R)) falls within the above range, the likelihood of the specific resin particles partially mixing with the binder resin to degrade dispersibility due to a high affinity between the binder resin and the specific resin particles is reduced compared with the case where the above difference is excessively small. When the difference (SP (S)−SP (R)) falls within the above range, the likelihood of the specific resin particles not being included in the toner particles and ejected onto the surfaces of the toner particles or to the outside of the toner particles due to a low affinity between the binder resin and the specific resin particles is reduced compared with the case where the above difference is excessively large.

The binder resin may include a crystalline resin and an amorphous resin.

The term “crystalline resin” used herein refers to a resin that exhibits a distinct endothermic peak instead of a step-like endothermic change in differential scanning calorimetry (DSC).

The term “amorphous resin” used herein refers to a resin that does not exhibit a distinct endothermic peak but only a step-like endothermic change in thermal analysis conducted using differential scanning calorimetry (DSC), that is solid at normal temperature, and that undergoes heat plasticization at a temperature equal to or higher than the glass transition temperature.

Specifically, for example, an crystalline resin is a resin that exhibits an endothermic peak with a half-width of 10° C. or less at a heating rate of 10° C./min. An amorphous resin is a resin the half-width of which is more than 10° C. or a resin that does not exhibit a distinct endothermic peak.

The crystalline resin is described below.

Examples of the crystalline resin include publicly known crystalline resins, such as a crystalline polyester resin and a crystalline vinyl resin (e.g., a polyalkylene resin or a long-chain alkyl (meth)acrylate resin). Among these, a crystalline polyester resin may be used in terms of the mechanical strength and low-temperature fixability of the toner.

Crystalline Polyester Resin

Examples of the crystalline polyester resin include condensation polymers of a polyvalent carboxylic acid and a polyhydric alcohol. The crystalline polyester resin may be commercially available one or a synthesized one.

In order to increase ease of forming a crystal structure, a condensation polymer prepared from linear aliphatic polymerizable monomers may be used as a crystalline polyester resin instead of a condensation polymer prepared from polymerizable monomers having an aromatic ring.

Examples of the polyvalent carboxylic acid include aliphatic dicarboxylic acids, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; aromatic dicarboxylic acids, such as dibasic acids (e.g., phthalic acid, isophthalic acid, terephthalic acid, and naphthalene-2,6-dicarboxylic acid); anhydrides of these dicarboxylic acids; and lower (e.g., 1 to 5 carbon atoms) alkyl esters of these dicarboxylic acids.

Trivalent or higher carboxylic acids having a crosslinked structure or a branched structure may be used as a polyvalent carboxylic acid in combination with the dicarboxylic acids. Examples of the trivalent carboxylic acids include aromatic carboxylic acids, such as 1,2,3-benzenetric arboxylic acid, 1,2,4-benzenetricarboxylic acid, and 1,2,4-naphthalenetricarboxylic acid; anhydrides of these tricarboxylic acids; and lower (e.g., 1 to 5 carbon atoms) alkyl esters of these tricarboxylic acids.

Dicarboxylic acids including a sulfonic group and dicarboxylic acids including an ethylenic double bond may be used as a polyvalent carboxylic acid in combination with the above dicarboxylic acids.

The above polyvalent carboxylic acids may be used alone or in combination of two or more.

Examples of the polyhydric alcohol include aliphatic diols, such as linear aliphatic diols including a backbone having 7 to 20 carbon atoms. Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among these aliphatic diols, 1,8-octanediol, 1,9-nonanediol, and 1,10-decanediol may be used.

Trihydric or higher alcohols having a crosslinked structure or a branched structure may be used as a polyhydric alcohol in combination with the above diols. Examples of the trihydric or higher alcohols include glycerin, trimethylolethane, trimethylolpropane, and pentaerythritol.

The above polyhydric alcohols may be used alone or in combination of two or more.

The content of the aliphatic diols in the polyhydric alcohol may be 80 mol % or more and is preferably 90 mol % or more.

The melting temperature of the crystalline polyester resin is preferably 50° C. or more and 100° C. or less, is more preferably 55° C. or more and 90° C. or less, and is further preferably 60° C. or more and 85° C. or less.

The melting temperature of the crystalline polyester resin is determined from the “melting peak temperature” according to a method for determining melting temperature which is described in JIS K 7121:1987 “Testing Methods for Transition Temperatures of Plastics” using a DSC curve obtained by differential scanning calorimetry (DSC).

The crystalline polyester resin may have a weight average molecular weight Mw of 6000 or more and 35000 or less.

The crystalline polyester resin may be produced by any suitable method known in the related art similarly to, for example, the amorphous polyester resin.

In the case where the toner particles include a crystalline resin, the content of the crystalline resin in the entire binder resin is preferably 4% by mass or more and 50% by mass or less, is more preferably 6% by mass or more and 30% by mass or less, and is further preferably 8% by mass or more and 20% by mass or less.

When the content of the crystalline resin falls within the above range, suitable fixability is likely to be achieved compared with the case where the content of the crystalline resin is lower than the above range. When the content of the crystalline resin falls within the above range, the likelihood of the glossiness of an image fixed under a high-temperature, high-pressure condition being excessively increased due to an excessively high content of a crystalline resin having relatively low elasticity may be reduced compared with the case where the content of the crystalline resin is higher than the above range. This results in a reduction in the difference in glossiness by condition.

The amorphous resin is described below.

Examples of the amorphous resin include publicly known amorphous resins, such as an amorphous polyester resin, an amorphous vinyl resin (e.g., a styrene acrylic resin), an epoxy resin, a polycarbonate resin, and a polyurethane resin. Among these, an amorphous polyester resin and an amorphous vinyl resin (in particular, a styrene acrylic resin) are preferable, and an amorphous polyester resin is more preferable.

Amorphous Polyester Resin

Examples of the amorphous polyester resin include condensation polymers of a polyvalent carboxylic acid and a polyhydric alcohol. The amorphous polyester resin may be a commercially available one or a synthesized one.

Examples of the polyvalent carboxylic acid include aliphatic dicarboxylic acids, such as oxalic acid, malonic acid, maleic acid, fumaric acid, citraconic acid, itaconic acid, glutaconic acid, succinic acid, alkenyl succinic acid, adipic acid, and sebacic acid; alicyclic dicarboxylic acids, such as cyclohexanedicarboxylic acid; aromatic dicarboxylic acids, such as terephthalic acid, isophthalic acid, phthalic acid, and naphthalenedicarboxylic acid; anhydrides of these dicarboxylic acids; and lower (e.g., 1 to 5 carbon atoms) alkyl esters of these dicarboxylic acids. Among these polyvalent carboxylic acids, aromatic dicarboxylic acids may be used.

Trivalent or higher carboxylic acids having a crosslinked structure or a branched structure may be used as a polyvalent carboxylic acid in combination with the dicarboxylic acids. Examples of the trivalent or higher carboxylic acids include trimellitic acid, pyromellitic acid, anhydrides of these carboxylic acids, and lower (e.g., 1 to 5 carbon atoms) alkyl esters of these carboxylic acids.

The above polyvalent carboxylic acids may be used alone or in combination of two or more.

Examples of the polyhydric alcohol include aliphatic diols, such as ethylene glycol, diethylene glycol, triethylene glycol, propylene glycol, butanediol, hexanediol, and neopentyl glycol; alicyclic diols, such as cyclohexanediol, cyclohexanedimethanol, and hydrogenated bisphenol A; and aromatic diols, such as bisphenol A-ethylene oxide adduct and bisphenol A-propylene oxide adduct. Among these polyhydric alcohols, for example, aromatic diols and alicyclic diols may be used. In particular, aromatic diols may be used.

Trihydric or higher alcohols having a crosslinked structure or a branched structure may be used as a polyhydric alcohol in combination with the diols. Examples of the trihydric or higher alcohols include glycerin, trimethylolpropane, and pentaerythritol.

The above polyhydric alcohols may be used alone or in combination of two or more.

The glass transition temperature Tg of the amorphous polyester resin is preferably 50° C. or more and 80° C. or less and is more preferably 50° C. or more and 65° C. or less.

The glass transition temperature of the amorphous polyester resin is determined from a differential scanning calorimetry (DSC) curve obtained by DSC. More specifically, the glass transition temperature of the amorphous polyester resin is determined from the “extrapolated glass-transition-starting temperature” according to a method for determining glass transition temperature which is described in JIS K 7121:1987 “Testing Methods for Transition Temperatures of Plastics”.

The weight average molecular weight Mw of the amorphous polyester resin is preferably 5000 or more and 1000000 or less and is more preferably 7000 or more and 500000 or less.

The number average molecular weight Mn of the amorphous polyester resin may be 2000 or more and 100000 or less.

The molecular weight distribution index Mw/Mn of the amorphous polyester resin is preferably 1.5 or more and 100 or less and is more preferably 2 or more and 60 or less.

The weight average molecular weight and number average molecular weight of the amorphous polyester resin are determined by gel permeation chromatography (GPC). Specifically, the molecular weights of the amorphous polyester resin are determined by GPC using a “HLC-8120GPC” produced by Tosoh Corporation as measuring equipment, a column “TSKgel SuperHM-M (15 cm)” produced by Tosoh Corporation, and a THF solvent. The weight average molecular weight and number average molecular weight of the amorphous polyester resin are determined on the basis of the results of the measurement using a molecular-weight calibration curve based on monodisperse polystyrene standard samples.

The amorphous polyester resin may be produced by any suitable production method known in the related art. Specifically, the amorphous polyester resin may be produced by, for example, a method in which polymerization is performed at 180° C. or more and 230° C. or less, the pressure inside the reaction system is reduced as needed, and water and alcohols that are generated by condensation are removed.

In the case where the raw materials, that is, the monomers, are not dissolved in or miscible with each other at the reaction temperature, a solvent having a high boiling point may be used as a dissolution adjuvant in order to dissolve the raw materials. In such a case, the condensation polymerization reaction is performed while the dissolution adjuvant is distilled away. In the case where a monomer having low miscibility is present, a condensation reaction of the monomers with an acid or alcohol that is to undergo a polycondensation reaction with the monomers may be performed in advance and subsequently polycondensation of the resulting polymers with the other components may be performed.

The binder resin may include a polyester resin having an aliphatic dicarboxylic acid unit (i.e., a structural unit derived from an aliphatic dicarboxylic acid). In the case where a polyester resin that serves as a binder resin has an aliphatic dicarboxylic acid unit, the flexibility of the binder resin is enhanced, the specific resin particles can be dispersed in a substantially homogeneous manner, and the change in loss tangent tan δ may be further reduced consequently, compared with the case where the binder resin has only an aromatic dicarboxylic acid unit.

The binder resin may include an amorphous polyester resin having an aliphatic dicarboxylic acid unit and a crystalline polyester resin having an aliphatic dicarboxylic acid unit. In the case where the binder resin includes an amorphous polyester resin and a crystalline polyester resin, when both amorphous polyester resin and crystalline polyester resin have an aliphatic dicarboxylic acid unit, the specific resin particles can be dispersed in the binder resin in a further homogeneous manner.

As an aliphatic dicarboxylic acid, for example, a saturated aliphatic dicarboxylic acid represented by General Formula “HOOC—(CH₂)ₙ—COOH” is preferably used. In General Formula above, n is preferably 4 to 20 and is further preferably 4 to 12.

The content of the binder resin is, for example, preferably 40% by mass or more and 95% by mass or less, is more preferably 50% by mass or more and 90% by mass or less, and is further preferably 60% by mass or more and 85% by mass or less of the whole amount of the toner particles.

The ratio of the content of the crystalline resin to the content of the specific resin particles is 0.2 or more and 10 or less and is more preferably 1 or more and 5 or less with the content of the specific resin particles being 1.

When the ratio of the content of the crystalline resin to the content of the specific resin particles falls within the above range, the likelihood of the fusibility of the toner being degraded due to an excessive reduction in a low-viscosity component of the toner at 90° C. or more 150° C. or less and an increase in the contribution of the specific resin particles, which is a high-elasticity component, is reduced and fixability is enhanced accordingly, compared with the case where the above ratio is less than 0.2.

When the ratio of the content of the crystalline resin to the content of the specific resin particles falls within the above range, the likelihood of the deformation of the toner due to the heat and pressure applied by the fuser being increased due to an excessive increase in the low-viscosity component is reduced and the difference in glossiness by fixing conditions is reduced, compared with the case where the above ratio is more than 10.

The ratio of the content of the amorphous resin to the content of the specific resin particles is preferably 1.3 or more and 45 or less and is more preferably 3 or more and 15 or less with the content of the specific resin particles being 1.

Specific Resin Particles

The specific resin particles are not limited and may be any resin particles such that the storage modulus G′ of the resin particles at 90° C. or more and 150° C. or less which is determined in the measurement of dynamic viscoelasticity at a heating rate of 2° C./min is 1×10⁴ Pa or more and 1×10⁶ Pa or less.

The storage modulus G′ of the resin particles at 90° C. or more and 150° C. or less is preferably 1×10⁵ Pa or more and 8×10⁵ Pa or less and is more preferably 1×10⁵ Pa or more and 6×10⁵ Pa or less.

When resin particles the storage modulus G′ of which at 90° C. or more and 150° C. or less falls within the above range are used, the likelihood of the glossiness of images fixed under a high-temperature, high-pressure condition being excessively increased is reduced compared with the case where resin particles the storage modulus G′ of which is lower than the above range are used. This results in a reduction in the difference in glossiness by condition. When resin particles the storage modulus G′ of which at 90° C. or more and 150° C. or less falls within the above range are used, the likelihood of fixability being degraded due to an excessive increase in the elasticity of the toner particles compared with the case where resin particles the storage modulus G′ of which is higher than the above range are used. As a result, suitable fixability is likely to be achieved.

The loss tangent tan δ of the specific resin particles at 30° C. or more and 150° C. or less which is determined in the measurement of dynamic viscoelasticity at a heating rate of 2° C./min is preferably 0.01 or more and 2.5 or less. In particular, the loss tangent tan δ of the specific resin particles at 65° C. or more and 150° C. or less is more preferably 0.01 or more and 1.0 or less and is further preferably 0.01 or more and 0.5 or less.

When the loss tangent tan δ of the specific resin particles at 30° C. or more and 150° C. or less falls within the above range, the toner particles are readily deformed during fixing and suitable fixability is likely to be achieved, compared with the case where the above loss tangent tan δ is lower than the above range. Moreover, when the loss tangent tan δ of the specific resin particles at 65° C. or more and 150° C. or less, at which the toner particles are readily deformed, falls within the above range, the likelihood of the glossiness of images fixed under a high-temperature, high-pressure condition being excessively increased is reduced and the difference in glossiness by condition is reduced consequently, compared with the case where the above loss tangent tan δ is higher than the above range.

The specific resin particles may be crosslinked resin particles.

The term “crosslinked resin particles” used herein refers to resin particles having a bridged structure formed between specific atoms included in the polymer structure of the resin particles.

When the specific resin particles are crosslinked resin particles, the specific resin particles the storage modulus G′ of which at 90° C. or more and 150° C. or less falls within the above range are likely to be formed and the specific toner is likely to be produced consequently.

Examples of the crosslinked resin particles include crosslinked resin particles crosslinked with an ionic bond (i.e., ionic crosslinked resin particles) and crosslinked resin particles crosslinked with a covalent bond (i.e., covalently crosslinked resin particles). Among the above crosslinked resin particles, crosslinked resin particles crosslinked with a covalent bond may be used.

Examples of the type of resin included in the crosslinked resin particles include polyolefin resins (e.g., polyethylene and polypropylene), styrene-based resins (e.g., polystyrene and α-polymethylstyrene), (meth)acrylic resins (e.g., polymethyl methacrylate and polyacrylonitrile), epoxy resins, polyurethane resins, polyurea resins, polyamide resins, polycarbonate resins, polyether resins, polyester resins, and copolymers thereof. The above resins may be used alone or in a mixture of two or more as needed.

Among the above resins, a styrene (meth)acrylic resin may be used as a resin included in the crosslinked resin particles.

That is, the crosslinked resin particles may be styrene (meth)acrylic resin particles.

When the crosslinked resin particles are styrene (meth)acrylic resin particles, the specific resin particles the storage modulus G′ of which at 90° C. or more and 150° C. or less falls within the above range are likely to be formed and the specific toner is likely to be produced consequently.

Examples of the styrene (meth)acrylic resin include a resin produced by radical polymerization of the styrene monomer described below with the (meth)acrylate monomer described below.

Examples of the styrene monomer include styrene, α-methylstyrene, and vinylnaphthalene; alkyl-substituted styrenes having an alkyl chain, such as 2-methylstyrene, 3-methylstyrene, 4-methylstyrene, 2-ethylstyrene, 3-ethylstyrene, and 4-ethylstyrene; halogen-substituted styrenes, such as 2-chloro styrene, 3-chloro styrene, and 4-chloro styrene; and fluorine-substituted styrenes, such as 4-fluoro styrene and 2,5-difluoro styrene. Among these, styrene and α-methylstyrene are preferable.

Examples of the (meth)acrylate monomer include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, 2-carboxyethyl (meth)acrylate, (meth)acrylonitrile, and (meth)acrylamide. Among these, n-butyl (meth)acrylate and 2-carboxyethyl (meth)acrylate are preferable.

Examples of the crosslinking agent used for crosslinking resins in the crosslinked resin particles include aromatic polyvinyl compounds, such as divinylbenzene and divinylnaphthalene; polyvinyl esters of aromatic polyvalent carboxylic acids, such as divinyl phthalate, divinyl isophthalate, divinyl terephthalate, divinyl homophthalate, trimesic acid divinyl ester, trimesic acid trivinyl ester, divinyl naphthalenedicarboxylate, and divinyl biphenylcarboxylate; divinyl esters of nitrogen-containing aromatic compounds, such as divinyl pyridinedicarboxylate; vinyl esters of unsaturated heterocyclic carboxylic acid compounds, such as vinyl pyromucate, vinyl furancarboxylate, vinyl pyrrole-2-carboxylate, and vinyl thiophenecarboxylate; (meth)acrylic acid esters of linear polyhydric alcohols, such as butanediol diacrylate, butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, dodecanediol diacrylate, and dodecanediol dimethacrylate; (meth)acrylic acid esters of branched or substituted polyhydric alcohols, such as neopentyl glycol dimethacrylate and 2-hydroxy,1,3-diacryloxypropane; and polyvinyl esters of polyvalent carboxylic acids, such as polyethylene glycol di(meth)acrylate, polypropylene polyethylene glycol di(meth)acrylates, divinyl succinate, divinyl fumarate, vinyl maleate, divinyl maleate, divinyl diglycolate, vinyl itaconate, divinyl itaconate, divinyl acetonedicarboxylate, divinyl glutarate, divinyl 3,3′-thiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. The above crosslinking agents may be used alone or in combination of two or more.

Among these, a difunctional alkyl acrylate having an alkylene chain having 6 or more carbon atoms is preferably used as a crosslinking agent for crosslinking resins. That is, the crosslinked resin particles preferably includes a difunctional alkyl acrylate as a structural unit, and the number of carbon atoms included in the alkylene chain of the difunctional alkyl acrylate is preferably 6 or more.

When crosslinked resin particles that have a difunctional alkyl acrylate as a structural unit and an alkylene chain having 6 or more carbon atoms are used, the specific toner is further readily produced. In the specific toner, it is important to limit the deformation of the toner particles to fall within a predetermined range even under a high-pressure fixing condition for reducing the difference in glossiness. In the case where the difference in elasticity between the specific resin particles that are the crosslinked resin particles and the binder resin is excessively large, the effect of the specific resin particles to reduce the change in loss tangent tan δ may fail to be produced to a sufficient degree. Thus, it is preferable to control the elasticity of the specific resin particles such that the elasticity of the specific resin particles is not increased to an excessive degree. The elasticity of the specific resin particles is excessively increased in the case where the crosslinking density of the specific resin particles is high (i.e., the distance between crosslinking points is short), while the excessive increase in the elasticity of the specific resin particles is limited in the case a difunctional acrylate having a long alkylene chain is used as a crosslinking agent and the crosslinking density is low (i.e., the distance between crosslinking points is long). This results in a further reduction in the difference in glossiness.

In order to adjust the above crosslinking density to fall within an adequate range, the number of carbon atoms included in the alkylene chain of the difunctional alkyl acrylate is preferably 6 or more, is more preferably 6 or more and 12 or less, and is further preferably 8 or more and 12 or less. Specific examples of the difunctional alkyl acrylate include 1,6-hexanediol acrylate, 1,6-hexanediol methacrylate, 1,8-octanediol diacrylate, 1,8-octanediol dimethacrylate, 1,9-nonanediol diacrylate, 1,9-nonanediol dimethacrylate, 1,10-decanediol diacrylate, 1,10-decanediol dimethacrylate, 1,12-dodecanediol diacrylate, and 1,12-dodecanediol dimethacrylate. Among these, 1,10-decanediol diacrylate and 1,10-decanediol dimethacrylate are preferable.

In the case where the specific resin particles are composed of a polymer of a specific resin particle-forming composition that includes a styrene monomer, a (meth)acrylate monomer, and a crosslinking agent, the viscoelasticity of the specific resin particles may be controlled by adjusting the content of the crosslinking agent in the composition. For example, increasing the content of the crosslinking agent in the composition increases the likelihood of production of resin particles having a high storage modulus G′. The content of the crosslinking agent in the specific resin particle-forming composition is, for example, 0.3 parts by mass or more and 5.0 parts by mass or less, is more preferably 0.5 parts by mass or more and 2.5 parts by mass or less, and is further preferably 1.0 parts by mass or more and 2.0 parts by mass or less relative to 100 parts by mass of the total amount of the styrene monomer, the (meth)acrylate monomer, and the crosslinking agent.

The glass transition temperature Tg of the specific resin particles which is determined by measurement of dynamic viscoelasticity is preferably 10° C. or more and 45° C. or less. When the glass transition temperature Tg of the specific resin particles is 10° C. or more and 45° C. or less, a toner that enables further suitable fixability to be achieved and reduces the difference in glossiness between an image fixed under a high-temperature, high-pressure condition and an image fixed under a low-temperature, low-pressure condition may be produced.

The glass transition temperature Tg of the specific resin particles is preferably 15° C. or more and 40° C. or less and is further preferably 20° C. or more and 35° C. or less.

When the glass transition temperature Tg of the specific resin particles falls within the above range, the likelihood of resin particles being unevenly distributed in the toner particles due to a large difference in Tg between the specific resin particles and the binder resin is reduced, the state in which the specific resin particles are dispersed in a homogeneous manner is readily maintained, the effect of reducing deformation caused by the pressure applied during fixing is readily produced, and the difference in glossiness is reduced consequently, compared with the case where Tg is excessively low. When the glass transition temperature Tg of the specific resin particles falls within the above range, the degradation of low temperature fixability which results from the degradation of fusibility of the binder resin may be limited, compared with the case where Tg is excessively high.

The number average size of the specific resin particles is preferably 60 nm or more and 300 nm or less, is more preferably 100 nm or more and 200 nm or less, and is further preferably 130 nm or more and 170 nm or less.

When the number average size of the specific resin particles falls within the above range, the degradation of fixability due to high susceptibility of the toner particles to high elasticity of the specific resin particles may be limited and suitable fixability may be achieved compared with the case where the above number average size is smaller than the above range. When the number average size of the specific resin particles falls within the above range, the specific resin particles are likely to be dispersed in the toner particles in a substantially homogeneous manner, a toner that has close viscoelasticity at both high temperature and a high strain and a low temperature and a low strain may be produced, and the difference in glossiness by condition may be reduced consequently, compared with the case where the above number average size is larger than the above range.

The number average size of the specific resin particles is determined using a transmission electron microscope (TEM).

Examples of the transmission electron microscope include JEM-1010 produced by JEOL DATUM LTD.

The method for determining the number average size of the specific resin particles is described below specifically.

A toner particle is sliced to a thickness of about 0.3 μm with a microtome. An image of a cross section of the toner particle is taken with a transmission electron microscope at a magnification of 4500 times. For each of 1000 resin particles dispersed inside the toner particle, the equivalent circle diameter of the resin particle is calculated on the basis of the cross-sectional area of the particle, and the arithmetic average thereof is considered as a number average particle size.

Alternatively, the number average size of the specific resin particles may be determined by analyzing a dispersion liquid of the specific resin particles with a laser diffraction particle size distribution analyzer (e.g., LA-700 produced by HORIBA, Ltd.).

The specific resin particles may be included in both regions close to the surfaces of the toner particles (hereinafter, also referred to as “surface regions”) and regions close to the centers of the toner particles (hereinafter, also referred to as “central regions”) uniformly. When the specific resin particles are included in both surface and central regions, the difference in glossiness by condition may be further reduced compared with the case where the specific resin particles are included in only the surface or central regions.

For example, in the case where the specific resin particles are included in only the surface regions, it is considered that the deformation of the toner particles is reduced under a low-temperature, low-pressure condition due to the impacts of viscoelasticity of the surface regions, while the deformation of the toner particles is increased under a high-temperature, high-pressure condition due to the impacts of viscoelasticity of the central regions. Accordingly, the difference in glossiness by condition may be increased. In the case where the specific resin particles are included in only the central regions, it is considered that the deformation of the toner particles is small and the state in which the specific resin particles are dispersed in the fixed image is poor (i.e., the specific resin particles are unevenly dispersed) under a low-temperature, low-pressure condition, while the deformation of the toner particles is large and the state in which the specific resin particles are dispersed in the fixed image is likely to be suitable (i.e., the specific resin particles are substantially homogeneously dispersed) under a high-temperature, high-pressure condition. In the case where the state in which the specific resin particles are dispersed in the fixed image is poor, the portions in which the specific resin particles are present are difficult to deform and form protrusions, while the portions in which the specific resin particles are absent are easy to deform and form recesses. Consequently, glossiness is reduced. In the case where the above dispersion state is suitable, the above-described state is limited and glossiness is increased. Consequently, the difference in glossiness by condition may be increased.

In contrast, in the case where the specific resin particles are included in both surface and central regions, it is considered that the difference in glossiness by condition is reduced, unlike the case where the specific resin particles are included in only the surface or central regions.

The content of the specific resin particles is preferably 2% by mass or more and 30% by mass or less, is more preferably 5% by mass or more and 25% by mass or less, and is further preferably 8% by mass or more and 20% by mass or less of the total amount of the toner particles.

When the content of the specific resin particles falls within the above range, a toner having close viscoelasticity at a high temperature and a high strain and at a low temperature and a low strain is likely to be produced and the difference in glossiness by condition is reduced, compared with the case where the above content is lower than the above range. When the content of the specific resin particles falls within the above range, the degradation of fixability caused due to excessively high elasticity of the toner particles may be limited and suitable fixability may be achieved, compared with the case where the above content is higher than the above range.

Colorant

Examples of the colorant include pigments, such as Carbon Black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watching Red, Permanent Red, Brilliant Carmine 3B, Brilliant Carmine 6B, DuPont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate; and dyes, such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

The above colorants may be used alone or in combination of two or more.

The colorant may optionally be subjected to a surface treatment and may be used in combination with a dispersant. Plural types of colorants may be used in combination.

For example, the content of the colorant in the entire toner particles is preferably 1% by mass or more and 30% by mass or less and is more preferably 3% by mass or more and 15% by mass or less.

Release Agent

Examples of the release agent include, but are not limited to, hydrocarbon waxes; natural waxes, such as a carnauba wax, a rice bran wax, and a candelilla wax; synthetic or mineral-petroleum-derived waxes, such as a montan wax; and ester waxes, such as a fatty-acid ester wax and a montanate wax.

The melting temperature of the release agent is preferably 50° C. or more and 110° C. or less and is more preferably 60° C. or more and 100° C. or less.

The above melting temperature is determined from the “melting peak temperature” according to a method for determining melting temperature which is described in JIS K 7121:1987 “Testing Methods for Transition Temperatures of Plastics” using a DSC curve obtained by differential scanning calorimetry (DSC).

For example, the content of the release agent in the entire toner particles is preferably 1% by mass or more and 20% by mass or less and is more preferably 5% by mass or more and 15% by mass or less.

Other Additives

Examples of the other additives include additives known in the related art, such as a magnetic substance, a charge-controlling agent, and an inorganic powder. These additives may be added to the toner particles as internal additives.

Relationships of Compositions of Toner Particles

Difference (SP (S)−SP (R))

The difference between the solubility parameter SP (S) of the specific resin particles and the solubility parameter SP (R) of the binder resin (SP (S)−SP (R)) is preferably −0.32 or more and −0.12 or less.

When the difference (SP (S)−SP (R)) falls within the above range, the affinity between the binder resin, which constitutes a large part of the toner particles, and the specific resin particles is maintained at an adequate level and the specific resin particles are readily dispersed inside the toner particles in a substantially homogeneous manner, compared with the case where the above difference is smaller than the above range. Consequently, a toner having close viscoelasticity at a high temperature and a high strain and at a low temperature and a low strain is likely to be produced and the difference in glossiness by condition is reduced. That is, the likelihood of the affinity between the binder resin and the specific resin particles being excessively increased to cause the specific resin particles to readily move inside the toner particles, the specific resin particles being partially aggregated with one another, and the advantageous effects of the specific resin particles being reduced is reduced, compared with the case where the difference (SP (S)−SP (R)) is smaller than the above range.

In the case where the difference (SP (S)−SP (R)) falls within the above range, the likelihood of the melt viscosity of the entire toner being increased as a result of the specific resin particles being mixed with the binder resin to an excessive degree when the toner is melted is reduced, compared with the case where the difference is larger than the above range. This advantageously limits the degradation of fixability caused due to excessively high viscoelasticity and enables suitable fixability to be achieved.

In the case where the binder resin is a resin mixture, the solubility parameter of a resin the content of which in the binder resin is the highest is used as SP (R).

The difference (SP (S)−SP (R)) is more preferably −0.29 or more and −0.18 or less. The solubility parameter SP (S) of the specific resin particles is preferably 9.00 or more and 9.15 or less, is more preferably 9.03 or more and 9.12 or less, and is further preferably 9.06 or more and 9.10 or less.

The solubility parameter SP (S) of the specific resin particles and the solubility parameter SP (R) of the binder resin (units: (cal/cm³)^{1/2}) are calculated using the Okitsu method. Details of the Okitsu method are described in “Journal of the Adhesion Society of Japan, Vol. 29, No. 5 (1993)”.

Viscoelasticity of Component (Remaining Component) from which Specific Resin Particles have been Removed

It is preferable that the storage modulus G′ of the component that remains after the specific resin particles have been removed from the toner particles at 30° C. or more and 50° C. or less be 1×10⁸ Pa or more and the temperature at which the storage modulus G′ reaches less than 1×10⁵ Pa be 65° C. or more and 90° C. or less. Hereinafter, the component that remains after the specific resin particles have been removed from the toner particles is also referred to as “remaining component”, and the temperature at which the storage modulus G′ reaches less than 1×10⁵ Pa is also referred to as “specific elasticity achieving temperature”. The remaining component the storage modulus G′ of which satisfies the above conditions has a high modulus of elasticity at low temperatures and a low modulus of elasticity at 65° C. or more and 90° C. or less. Therefore, when the storage modulus G′ of the remaining component satisfies the above conditions, the toner particles can be easily melted by heat and suitable fixability may be achieved compared with the case where the temperature at which the storage modulus G′ reaches less than 1×10⁵ Pa is more than 90° C.

The storage modulus G′ of the remaining component at 30° C. or more and 50° C. or less is preferably 1×10⁸ Pa or more, is more preferably 1×10⁸ Pa or more and 1×10⁹ Pa or less, and is further preferably 2×10⁸ Pa or more and 6×10⁸ Pa or less.

When the storage modulus G′ of the remaining component at 30° C. or more and 50° C. or less falls within the above range, the toner has suitable storage stability compared with the case where the above storage modulus G′ is lower than the above range and suitable fixability is likely to be achieved compared with the case where the above storage modulus G′ is higher than the above range.

The specific elasticity achieving temperature of the remaining component is preferably 65° C. or more and 90° C. or less, is more preferably 68° C. or more and 80° C. or less, and is further preferably 70° C. or more and 75° C. or less.

When the specific elasticity achieving temperature of the remaining component falls within the above range, the toner has suitable storage stability compared with the case where the above specific elasticity achieving temperature is lower than the above range and suitable fixability is likely to be achieved compared with the case where the above specific elasticity achieving temperature is higher than the above range.

The loss tangent tan δ of the remaining component at the specific elasticity achieving temperature is preferably 0.8 or more and 1.6 or less, is more preferably 0.9 or more and 1.5 or less, and is further preferably 1.0 or more and 1.4 or less.

When the loss tangent tan δ of the remaining component at the specific elasticity achieving temperature falls within the above range, suitable fixability is likely to be achieved compared with the case where the above loss tangent tan δ is lower than the above range. When the loss tangent tan δ of the remaining component at the specific elasticity achieving temperature falls within the above range, the difference in glossiness by condition may be reduced compared with the case where the above loss tangent tan δ is higher than the above range.

The storage modulus G′ and loss tangent tan δ of the remaining component are determined in the following manner.

Specifically, first, the resin particles are removed from the toner particles in order to obtain only the remaining component. The remaining component is formed into a tablet form at 25° C. with a press forming machine to prepare a measurement sample. For removing the resin particles from the toner particles to obtain only the remaining component, for example, the toner particles may be immersed in a solvent in which the binder resin is soluble and the resin particles are not soluble and then the remaining component may be extracted.

The resulting measurement sample is sandwiched between parallel plates having a diameter of 8 mm. Dynamic viscoelasticity is measured under the following conditions, at a strain of 0.1% to 100% while the measurement temperature is increased from 30° C. to 150° C. at 2° C./min. The storage modulus G′ and loss tangent tan δ are determined on the basis of the storage modulus and loss modulus curves prepared in the above measurement.

—Measurement Conditions—
Measuring equipment: Rheometer ARES-G2 (produced by TA Instruments, Inc.)
Measurement jig: 8-mm parallel plate
Gap: adjusted to 3 mm
Frequency: 1 Hz

Relationship Between Specific Resin Particles, Toner Particles, and Remaining Component

When the storage moduli of the specific resin particles, the toner particles, and the component that remains after the specific resin particles have been removed from the toner particles at 90° C. or more and 150° C. or less are defined as G′(p90-150), G′(t90-150), and G′(r90-150), respectively, it is preferable that G′(p90-150) be 1×10⁴ Pa or more and 1×10⁶ Pa or less and log G′(t90-150)−log G′(r90-150) be 1.0 or more and 4.0 or less.

The value of log G′(t90-150)−log G′(r90-150) is more preferably 1.0 or more and 3.5 or less, is further preferably 1.1 or more and 3.4 or less, and is particularly preferably 1.2 or more and 3.3 or less.

The value of log G′(t90-150)−log G′(r90-150) means a change in the viscoelasticity of the toner particles which occurs due to the addition of the specific resin particles. When the specific resin particles are dispersed and included inside the toner particles in a substantially homogeneous manner, the impacts of the viscoelasticity of the specific resin particles on the viscoelasticity of the entire toner particles are reduced. When the value of log G′(t90-150) −log G′(r90-150) is controlled to fall within the above range, both suitable fixability and reduction in the difference in glossiness by condition may be achieved compared with the case where the above value is smaller or larger than the above range.

Properties, Etc. of Toner Particles

The toner particles may have a single-layer structure or a “core-shell” structure constituted by a core (i.e., core particle) and a coating layer (i.e., shell layer) covering the core.

The core-shell structure of the toner particles may be constituted by, for example, a core including the binder resin, the specific resin particles, and, as needed, other additives such as a colorant and a release agent and by a coating layer including the binder resin and the specific resin particles.

In the case where the toner particles have the core-shell structure, it is preferable that both core particle and shell layer include the specific resin particles. When both core particle and shell layer include the specific resin particles, both surface and central regions of the toner particles include the specific resin particles and, consequently, the difference in glossiness by condition may be further reduced.

The volume average diameter (D50v) of the toner particles is preferably 2 μm or more and 10 μm or less, is more preferably 4 μm or more and 8 μm or less, and is further preferably 4 μm or more and 6 μm or less.

The various average particle sizes and various particle size distribution indices of the toner particles are measured using “COULTER MULTISIZER II” produced by Beckman Coulter, Inc. with an electrolyte “ISOTON-II” produced by Beckman Coulter, Inc. in the following manner.

A sample to be measured (0.5 mg or more and 50 mg or less) is added to 2 ml of a 5%-aqueous solution of a surfactant (e.g., sodium alkylbenzene sulfonate) that serves as a dispersant. The resulting mixture is added to 100 ml or more and 150 ml or less of an electrolyte.

The resulting electrolyte containing the sample suspended therein is subjected to a dispersion treatment for 1 minute using an ultrasonic disperser, and the distribution of the diameters of particles having a diameter of 2 μm or more and 60 μm or less is measured using COULTER MULTISIZER II with an aperture having a diameter of 100 μm. The number of the particles sampled is 50000.

The particle diameter distribution measured is divided into a number of particle diameter ranges (i.e., channels). For each range, in ascending order in terms of particle diameter, the cumulative volume and the cumulative number are calculated and plotted to draw cumulative distribution curves. Particle diameters at which the cumulative volume and the cumulative number reach 16% are considered to be the volume particle diameter D16v and the number particle diameter D16p, respectively. Particle diameters at which the cumulative volume and the cumulative number reach 50% are considered to be the volume average particle diameter D50v and the number average particle diameter D50p, respectively. Particle diameters at which the cumulative volume and the cumulative number reach 84% are considered to be the volume particle diameter D84v and the number particle diameter D84p, respectively.

Using the volume particle diameters and number particle diameters measured, the volume particle size distribution index (GSDv) is calculated as (D84v/D16v)^{1/2} and the number particle size distribution index (GSDp) is calculated as (D84p/D16p)^{1/2}.

The toner particles preferably has an average circularity of 0.94 or more and 1.00 or less. The average circularity of the toner particles is more preferably 0.95 or more and 0.98 or less.

The average circularity of the toner particles is determined as [Equivalent circle perimeter]/[Perimeter] (i.e., [Perimeter of a circle having the same projection area as the particles]/[Perimeter of the projection image of the particles]. Specifically, the average circularity of the toner particles is determined by the following method.

The toner particles to be measured are sampled by suction so as to form a flat stream. A static image of the particles is taken by instantaneously flashing a strobe light. The image of the particles is analyzed with a flow particle image analyzer “FPIA-3000” produced by Sysmex Corporation. The number of samples used for determining the average circularity of the toner particles is 3500.

In the case where the toner includes an external additive, the toner (i.e., the developer) to be measured is dispersed in water containing a surfactant and then subjected to an ultrasonic wave treatment in order to remove the external additive from the toner particles. External Additive

Examples of the external additive include inorganic particles. Examples of the inorganic particles include SiO₂ particles, TiO₂ particles, Al₂O₃ particles, CuO particles, ZnO particles, SnO₂ particles, CeO₂ particles, Fe₂O₃ particles, MgO particles, BaO particles, CaO particles, K₂O particles, Na₂O particles, ZrO₂ particles, CaOSiO₂ particles, K₂O (TiO₂)ₙ particles, Al₂O₃·2SiO₂ particles, CaCO₃ particles, MgCO₃ particles, BaSO₄ particles, and MgSO₄ particles.

The surfaces of the inorganic particles used as an external additive may be subjected to a hydrophobic treatment. The hydrophobic treatment is performed by, for example, immersing the inorganic particles in a hydrophobizing agent. Examples of the hydrophobizing agent include, but are not limited to, a silane coupling agent, a silicone oil, a titanate coupling agent, and aluminum coupling agent. These hydrophobizing agents may be used alone or in combination of two or more.

The amount of the hydrophobizing agent is commonly, for example, 1 part by mass or more and 10 parts by mass or less relative to 100 parts by mass of the inorganic particles.

Examples of the external additive further include particles of a resin, such as polystyrene, polymethyl methacrylate (PMMA), or a melamine resin; and particles of a cleaning lubricant, such as a metal salt of a higher fatty acid, such as zinc stearate, or a fluorine-contained resin.

The amount of the external additive used is, for example, preferably 0.01% by mass or more and 5.0% by mass or less and is more preferably 0.01% by mass or more and 2.0% by mass or less of the amount of the toner particles.

Properties of Toner Viscoelasticity of Toner

As described above, the toner according to this exemplary embodiment is the specific toner. That is, D1(90), D50(90), D1(150), and D50(150) are all 0.5 or more and 2.5 or less, D50(150)−D1(150) is less than 1.5, and D50(90)−D1(90) is less than 1.0.

The D1(90), D50(90), D1(150), and D50(150) of the specific toner are each 0.5 or more and 2.5 or less, are each preferably 0.5 or more and 2.0 or less, are each more preferably 0.6 or more and 1.8 or less, and are each further preferably 0.8 or more and 1.6 or less. When D1(90), D50(90), D1(150), and D50(150) all fall within the above range, suitable fixability may be achieved compared with the case where the above values are smaller than the above range and the difference in glossiness by condition may be reduced compared with the case where the above values are larger than the above range.

D50(150)−D1(150) of the specific toner is less than 1.5, is preferably 1.2 or less, and is further preferably 1.0 or less. When the value of D50(150)−D1(150) falls within the above range, the difference in glossiness by condition may be reduced compared with the case where the above value is larger than the above range. The value of D50(150)−D1(150) is preferably minimized in order to reduce the difference in glossiness by condition.

The lower limit for D50(150)−D1(150) is not limited.

The value of D50(90)−D1(90) of the specific toner is less than 1.0, is preferably less than 0.5, is more preferably 0.4 or less, and is further preferably 0.3 or less. When the value of D50(90)−D1(90) falls within the above range, the difference in glossiness by condition may be reduced compared with the case where the above value is larger than the above range. The value of D50(90)−D1(90) is preferably minimized in order to reduce the difference in glossiness by condition.

The lower limit for D50(90)−D1(90) is not limited.

It is preferable that the storage modulus G′ of the toner at 30° C. or more and 50° C. or less which is determined by measurement of dynamic viscoelasticity at a heating rate of 2° C./min be 1×10⁸ Pa or more and that the temperature at which the above storage modulus G′ reaches less than 1×10⁵ Pa (i.e., the specific elasticity achieving temperature) be 65° C. or more and 90° C. or less. The toner the storage modulus G′ of which satisfies the above conditions has a high modulus of elasticity at low temperatures and a low modulus of elasticity at 65° C. or more and 90° C. or less. Therefore, when the storage modulus G′ of the toner satisfies the above conditions, the toner can be easily melted by heat and suitable fixability may be achieved compared with the case where the temperature at which the storage modulus G′ reaches less than 1×10⁵ Pa is more than 90° C.

The storage modulus G′ of the toner at 30° C. or more and 50° C. or less is preferably 1×10⁸ Pa or more, is more preferably 1×10⁸ Pa or more and 1×10⁹ Pa or less, and is further preferably 2×10⁸ Pa or more and 6×10⁸ Pa or less.

When the storage modulus G′ of the toner at 30° C. or more and 50° C. or less falls within the above range, the toner has suitable storage stability compared with the case where the above storage modulus G′ is lower than the above range and suitable fixability is likely to be achieved compared with the case where the above storage modulus G′ is higher than the above range.

The specific elasticity achieving temperature of the toner is preferably 65° C. or more and 90° C. or less, is more preferably 70° C. or more and 87° C. or less, and is further preferably 75° C. or more and 84° C. or less.

When the specific elasticity achieving temperature of the toner falls within the above range, the toner has suitable storage stability compared with the case where the above specific elasticity achieving temperature is lower than the above range and suitable fixability is likely to be achieved compared with the case where the above specific elasticity achieving temperature is higher than the above range.

The storage modulus G′ and specific elasticity achieving temperature of the toner are determined in the following manner.

Specifically, the toner that is to be analyzed is formed into a tablet form at normal temperature (25° C.) with a press forming machine to prepare a measurement sample. The resulting measurement sample is sandwiched between parallel plates having a diameter of 8 mm. Dynamic viscoelasticity is measured under the following conditions, at a strain of 0.1% to 100% while the measurement temperature is increased from 30° C. to 150° C. at 2° C./min. The storage modulus G′ is determined on the basis of the storage modulus and loss modulus curves prepared in the above measurement.

—Measurement Conditions—
Measuring equipment: Rheometer ARES-G2 (produced by TA Instruments, Inc.)
Measurement jig: 8-mm parallel plate
Gap: adjusted to 3 mm
Frequency: 1 Hz

Method for Producing Toner

A method for producing the toner according to this exemplary embodiment is described below.

The toner according to the exemplary embodiment is produced by, after the preparation of the toner particles, depositing an external additive on the surfaces of the toner particles as needed.

The toner particles may be produced using either a dry process (e.g., knead pulverization) or a wet process (e.g., aggregation coalescence, suspension polymerization, or dissolution suspension). The method for preparing the toner particles is not limited thereto, and any suitable method known in the related art may be used.

Among these, aggregation coalescence may be used in order to prepare the toner particles.

Specifically, for example, in the case where aggregation coalescence is used for producing the toner particles, the toner particles are produced by the following steps:
preparing a resin particle dispersion liquid in which particles of a resin that serves as a binder resin are dispersed and a specific resin particle dispersion liquid that serves as the specific resin particles (resin particle dispersion liquid preparation step);
causing the resin particles (and other particles as needed) to aggregate with one another in the resin particle dispersion liquid (or a dispersion liquid that further includes the other particle dispersion liquid as needed) to form aggregated particles (aggregated particle formation step); and
heating the resulting aggregated particle dispersion liquid in which the aggregated particles are dispersed to cause fusion and coalescence of the aggregated particles and form toner particles (fusion and coalescence step).

Each of the above steps is described below in detail.

Hereinafter, a method for preparing toner particles including a colorant and a release agent is described. However, it should be noted that the colorant and the release agent are optional. It is needless to say that additives other than a colorant or a release agent may be used.

Resin Particle Dispersion Liquid Preparation Step

First, a resin particle dispersion liquid in which particles of a resin that serves as a binder resin are dispersed is prepared. Furthermore, for example, a colorant particle dispersion liquid in which particles of a colorant are dispersed and a release agent particle dispersion liquid in which particles of a release agent are dispersed are prepared.

The resin particle dispersion liquid is prepared by, for example, dispersing the resin particles in a dispersion medium using a surfactant.

Examples of the dispersion medium used for preparing the resin particle dispersion liquid include aqueous media.

Examples of the aqueous media include water, such as distilled water and ion-exchange water; and alcohols. These aqueous media may be used alone or in combination of two or more.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. Among these surfactants, in particular, the anionic surfactants and the cationic surfactants may be used. The nonionic surfactants may be used in combination with the anionic surfactants and the cationic surfactants.

These surfactants may be used alone or in combination of two or more.

In the preparation of the resin particle dispersion liquid, the resin particles can be dispersed in a dispersion medium by any suitable dispersion method commonly used in the related art in which, for example, a rotary-shearing homogenizer, a ball mill, a sand mill, or a dyno mill that includes media is used. Depending on the type of the resin particles used, the resin particles may be dispersed in the resin particle dispersion liquid by, for example, phase-inversion emulsification.

Phase-inversion emulsification is a method in which the resin to be dispersed is dissolved in a hydrophobic organic solvent in which the resin is soluble, a base is added to the resulting organic continuous phase (i.e., 0 phase) to perform neutralization, and subsequently an aqueous medium (i.e., W phase) is charged in order to perform conversion of resin (i.e., phase inversion) from W/O to O/W, form a discontinuous phase, and disperse the resin in the aqueous medium in the form of particles.

The volume average diameter of the resin particles dispersed in the resin particle dispersion liquid is preferably, for example, 0.01 μm or more and 1 μm or less, is more preferably 0.08 μm or more and 0.8 μm or less, and is further preferably 0.1 μm or more and 0.6 μm or less.

The volume average diameter of the resin particles is determined in the following manner. The particle diameter distribution of the resin particles is obtained using a laser-diffraction particle-size-distribution measurement apparatus, such as “LA-700” produced by HORIBA, Ltd. The particle diameter distribution measured is divided into a number of particle diameter ranges (i.e., channels). For each range, in ascending order in terms of particle diameter, the cumulative volume is calculated and plotted to draw a cumulative distribution curve. A particle diameter at which the cumulative volume reaches 50% is considered to be the volume particle diameter D50v. The volume average diameters of particles included in the other dispersion liquids are also determined in the above-described manner.

The content of the resin particles included in the resin particle dispersion liquid is, for example, preferably 5% by mass or more and 50% by mass or less and is more preferably 10% by mass or more and 40% by mass or less.

The colorant particle dispersion liquid, the release agent particle dispersion liquid, and the like are also prepared as in the preparation of the resin particle dispersion liquid. In other words, the above-described specifications for the volume average diameter of the particles included in the resin particle dispersion liquid, the dispersion medium of the resin particle dispersion liquid, the dispersion method used for preparing the resin particle dispersion liquid, and the content of the particles in the resin particle dispersion liquid can also be applied to colorant particles dispersed in the colorant particle dispersion liquid and release agent particles dispersed in the release agent particle dispersion liquid.

Preparation of Specific Resin Particle Dispersion Liquid

Publicly known methods, such as emulsion polymerization, a melt-kneading method in which a Banbury mixer, a kneader, or the like is used, suspension polymerization, and spray drying, may be used for preparing the specific resin particle dispersion liquid. Among these, emulsion polymerization may be used.

In order to adjust the storage modulus G′ and loss tangent tan δ of the specific resin particles to fall within the above preferable ranges, a styrene monomer and a (meth)acrylate monomer are preferably used as monomers and polymerized with each other in the presence of a crosslinking agent.

In the production of the specific resin particles, emulsion polymerization may be performed in a plurality of stages.

The method for producing the specific resin particles is specifically described below.

The method for preparing the specific resin particle dispersion liquid may include the following steps:
preparing an emulsion including monomers, a crosslinking agent, a surfactant, and water (emulsion preparation step);
adding a polymerization initiator to the emulsion and heating the resulting mixture to cause polymerization of the monomers (first emulsion polymerization step); and
adding an emulsion including monomers and a crosslinking agent to the reaction solution produced by the first emulsion polymerization step and heating the resulting mixture to cause polymerization of the monomers (second emulsion polymerization step).

Emulsion Preparation Step

The emulsion preparation step is a step of preparing an emulsion including monomers, a crosslinking agent, a surfactant, and water.

The emulsion may be prepared by emulsifying monomers, a crosslinking agent, a surfactant, and water with an emulsifier.

Examples of the emulsifier include a rotary stirrer equipped with a propeller-type, anchor-type, paddle-type, or turbine-type impeller; a static mixing machine, such as a static mixer; a homogenizer; a rotor-stator emulsifier, such as CLEARMIX; a mill emulsifier having a grinding function; a high-pressure emulsifier, such as a Manton-Gaulin pressure emulsifier; a high-pressure nozzle emulsifier that generates cavitation at high pressures; a high-pressure collision emulsifier that generates a shear force by causing liquid particles to collide with one another at high pressures, such as Microfluidizer; an ultrasonic emulsifier that generates cavitation using ultrasonic waves; and a membrane emulsifier that performs homogeneous emulsification through pores.

A styrene monomer and a (meth)acrylate monomer may be used as monomers.

The crosslinking agent may be the above-described crosslinking agent.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. The nonionic surfactants may be used in combination with the anionic surfactants and the cationic surfactants. Among these surfactants, the anionic surfactants may be used. These surfactants may be used alone or in combination of two or more.

The emulsion may include a chain transfer agent. The chain transfer agent may be, but not limited to, a compound having a thiol component. Specific examples thereof include alkyl mercaptans, such as hexyl mercaptan, heptyl mercaptan, octyl mercaptan, nonyl mercaptan, decyl mercaptan, and dodecyl mercaptan.

In order to adjust the storage modulus G′ and loss tangent tan δ of the specific resin particles to fall within the preferable ranges, the mass ratio between the styrene monomer and (meth)acrylate monomer included in the emulsion (styrene monomer/(meth)acrylate monomer) is preferably 0.2 or more and 1.1 or less.

In order to adjust the storage modulus G′ and loss tangent tan δ of the specific resin particles to fall within the preferable ranges, the content of the crosslinking agent is preferably 0.5% by mass or more and 3% by mass or less of the total amount of the emulsion.

First Emulsion Polymerization Step

The first emulsion polymerization step is a step of adding a polymerization initiator to the emulsion and heating the resulting mixture to cause polymerization of the monomers.

When polymerization is performed, the emulsion (reaction solution) including the polymerization initiator may be stirred with a stirrer.

Examples of the stirrer include a rotary stirrer equipped with a propeller-type, anchor-type, paddle-type, or turbine-type impeller.

Ammonium persulfate may be used as a polymerization initiator.

In the case where the polymerization initiator is used, the viscoelasticity of the specific resin particles may be controlled by adjusting the amount of the polymerization initiator added. For example, reducing the amount of the polymerization initiator added increases the likelihood of production of resin particles having a high storage modulus G′.

Second Emulsion Polymerization Step

The second emulsion polymerization step is a step of adding an emulsion including monomers to the reaction solution produced in the first emulsion polymerization step and heating the resulting mixture to cause polymerization of the monomers.

When polymerization is performed, the reaction solution may be stirred as in the first emulsion polymerization step.

In this step, the viscoelasticity of the specific resin particles may be controlled by adjusting the amount of time during which the emulsion including the monomers is added. For example, increasing the amount of time during which the emulsion including the monomers is added increases the likelihood of production of resin particles having a high storage modulus G′. The amount of time during which the emulsion including the monomers is added is, for example, 2 hours or more and 5 hours or less.

In this step, the viscoelasticity of the specific resin particles may be controlled by adjusting the temperature at which the reaction solution is stirred. For example, lowering the temperature at which the reaction solution is stirred increases the likelihood of production of resin particles having a high storage modulus G′. The temperature at which the reaction solution is stirred is, for example, 55° C. or more and 75° C. or less.

The emulsion including monomers may be produced by, for example, emulsifying the monomer, a surfactant, and water with an emulsifier.

Aggregated Particle Formation Step

The resin particle dispersion liquid is mixed with the colorant particle dispersion liquid, the release agent particle dispersion liquid, and the specific resin particle dispersion liquid.

In the resulting mixed dispersion liquid, heteroaggregation of the resin particles with the colorant particles, the release agent particles, and the specific resin particles is performed in order to form aggregated particles including the resin particles, the colorant particles, the release agent particles, and the specific resin particles, the aggregated particles having a diameter closer to that of the intended toner particles.

Specifically, for example, a coagulant is added to the mixed dispersion liquid, and the pH of the mixed dispersion liquid is controlled to be acidic (e.g., pH of 2 or more and 5 or less). A dispersion stabilizer may be added to the mixed dispersion liquid as needed. Subsequently, the mixed dispersion liquid is heated to the glass transition temperature of the resin particles (specifically, e.g., [Glass transition temperature of the resin particles—30° C.] or more and [the Glass transition temperature—10° C.] or less), and thereby the particles dispersed in the mixed dispersion liquid are caused to aggregate together to form aggregated particles.

In the aggregated particle formation step, alternatively, for example, the above coagulant may be added to the mixed dispersion liquid at room temperature (e.g., 25° C.) while the mixed dispersion liquid is stirred using a rotary-shearing homogenizer. Then, the pH of the mixed dispersion liquid is controlled to be acidic (e.g., pH of 2 or more and 5 or less), and a dispersion stabilizer may be added to the mixed dispersion liquid as needed. Subsequently, the mixed dispersion liquid is heated in the above-described manner.

In this step, the state in which the specific resin particles are dispersed in the toner particles may be controlled by adjusting the temperature of the mixed dispersion liquid to which the coagulant is added. For example, reducing the temperature of the mixed dispersion liquid enhances the dispersibility of the specific resin particles. The temperature of the mixed dispersion liquid is, for example, 5° C. or more and 40° C. or less.

In this step, the state in which the specific resin particles are dispersed in the toner particles may be also controlled by adjusting the agitation speed subsequent to the addition of the coagulant. For example, increasing the agitation speed subsequent to the addition of the coagulant enhances the dispersibility of the specific resin particles.

Examples of the coagulant include surfactants, inorganic metal salts, and divalent or higher metal complexes that have a polarity opposite to that of the surfactant included in the mixed dispersion liquid as a dispersant. In particular, using a metal complex as a coagulant reduces the amount of surfactant used and, as a result, charging characteristics may be enhanced.

An additive capable of forming a complex or a bond similar to a complex with the metal ions contained in the coagulant may optionally be used. An example of the additive is a chelating agent.

Examples of the inorganic metal salts include metal salts, such as calcium chloride, calcium nitrate, barium chloride, magnesium chloride, zinc chloride, aluminum chloride, and aluminum sulfate; and inorganic metal salt polymers, such as polyaluminum chloride, polyaluminum hydroxide, and calcium polysulfide.

The chelating agent may be a water-soluble chelating agent. Examples of such a chelating agent include oxycarboxylic acids, such as tartaric acid, citric acid, and gluconic acid; and iminodiacetic acid (IDA), nitrilotriacetic acid (NTA), and ethylenediaminetetraacetic acid (EDTA).

The amount of the chelating agent used is, for example, preferably 0.01 parts by mass or more and 5.0 parts by mass or less and is more preferably 0.1 parts by mass or more and less than 3.0 parts by mass relative to 100 parts by mass of the resin particles.

Fusion Coalescence Step

The aggregated particle dispersion liquid in which the aggregated particles are dispersed is heated to, for example, a temperature equal to or higher than the glass transition temperature of the resin particles (e.g., [Glass transition temperature of the resin particles+10° C.] or more and [the Glass transition temperature+30° C.] or less) in order to perform fusion and coalescence of the aggregated particles and form toner particles.

The toner particles are produced through the above-described steps.

The toner particles may be produced by, subsequent to the preparation of the aggregated particle dispersion liquid in which the aggregated particles are dispersed, mixing the aggregated particle dispersion liquid with a resin particle dispersion liquid in which resin particles are dispersed and a specific resin particle dispersion liquid in which the specific resin particles are dispersed and causing aggregation such that the resin particles and the specific resin particles are adhered onto the surfaces of the aggregated particles to form second aggregated particles; and heating a second aggregated particle dispersion liquid in which the second aggregated particles are dispersed to cause fusion and coalescence of the second aggregated particles and form toner particles having a core-shell structure.

In the step of forming the second aggregated particles, the addition of the resin particle dispersion liquid and the specific resin particle dispersion liquid and the adhesion of the resin particles and the specific resin particles onto the surfaces of the aggregated particles may be repeated a plurality of times. When the above operation is repeatedly done a plurality of times, toner particles that include the specific resin particles dispersed uniformly in both surface and central regions of the toner particles may be produced.

After the completion of the fusion-coalescence step, the toner particles formed in the solution are subjected to any suitable cleaning step, solid-liquid separation step, and drying step that are known in the related art in order to obtain dried toner particles.

In the cleaning step, the toner particles may be subjected to displacement washing using ion-exchange water to a sufficient degree from the viewpoint of electrification characteristics. Examples of a solid-liquid separation method used in the solid-liquid separation step include, but are not limited to, suction filtration and pressure filtration from the viewpoint of productivity. Examples of a drying method used in the drying step include, but are not limited to, freeze-drying, flash drying, fluidized drying, and vibrating fluidized drying from the viewpoint of productivity.

The toner according to the exemplary embodiment is produced by, for example, adding an external additive to the dried toner particles and mixing the resulting toner particles using a V-blender, a HENSCHEL mixer, a Lodige mixer, or the like. Optionally, coarse toner particles may be removed using a vibrating screen classifier, a wind screen classifier, or the like.

Electrostatic Image Developer

An electrostatic image developer according to the exemplary embodiment includes at least the toner according to the exemplary embodiment.

The electrostatic image developer according to the exemplary embodiment may be a single component developer including only the toner according to the exemplary embodiment or may be a two-component developer that is a mixture of the toner and a carrier.

The type of the carrier is not limited, and any suitable carrier known in the related art may be used. Examples of the carrier include a coated carrier prepared by coating the surfaces of cores including magnetic powder particles with a resin; a magnetic-powder-dispersed carrier prepared by dispersing and mixing magnetic powder particles in a matrix resin; and a resin-impregnated carrier prepared by impregnating a porous magnetic powder with a resin.

The magnetic-powder-dispersed carrier and the resin-impregnated carrier may also be prepared by coating the surfaces of particles constituting the carrier, that is, core particles, with a resin.

Examples of the magnetic powder include powders of magnetic metals, such as iron, nickel, and cobalt; and powders of magnetic oxides, such as ferrite and magnetite.

Examples of the coat resin and the matrix resin include polyethylene, polypropylene, polystyrene, poly(vinyl acetate), poly(vinyl alcohol), poly(vinyl butyral), poly(vinyl chloride), poly(vinyl ether), poly(vinyl ketone), a vinyl chloride-vinyl acetate copolymer, a styrene-acrylic acid ester copolymer, a straight silicone resin including an organosiloxane bond and the modified products thereof, a fluorine resin, polyester, polycarbonate, a phenolic resin, and an epoxy resin.

The coat resin and the matrix resin may optionally include additives, such as conductive particles.

Examples of the conductive particles include particles of metals, such as gold, silver, and copper; and particles of carbon black, titanium oxide, zinc oxide, tin oxide, barium sulfate, aluminum borate, and potassium titanate.

The surfaces of the cores can be coated with a resin by, for example, using a coating-layer forming solution prepared by dissolving the coat resin and, as needed, various types of additives in a suitable solvent. The type of the solvent is not limited and may be selected with consideration of the type of the resin used, ease of applying the coating-layer forming solution, and the like.

Specific examples of a method for coating the surfaces of the cores with the coat resin include an immersion method in which the cores are immersed in the coating-layer forming solution; a spray method in which the coating-layer forming solution is sprayed onto the surfaces of the cores; a fluidized-bed method in which the coating-layer forming solution is sprayed onto the surfaces of the cores while the cores are floated using flowing air; and a kneader-coater method in which the cores of the carrier are mixed with the coating-layer forming solution in a kneader coater and subsequently the solvent is removed.

The mixing ratio (i.e., mass ratio) of the toner to the carrier in the two-component developer is preferably toner:carrier=1:100 to 30:100 and is more preferably 3:100 to 20:100.

Image Forming Apparatus and Image Forming Method

An image forming apparatus and an image forming method according to the exemplary embodiment are described below.

The image forming apparatus according to the exemplary embodiment includes an image holding member; a charging unit that charges the surface of the image holding member; an electrostatic image formation unit that forms an electrostatic image on the charged surface of the image holding member; a developing unit that includes an electrostatic image developer and develops the electrostatic image formed on the surface of the image holding member with the electrostatic image developer to form a toner image; a transfer unit that transfers the toner image formed on the surface of the image holding member onto the surface of a recording medium; and a fixing unit that fixes the toner image onto the surface of the recording medium. The electrostatic image developer is the electrostatic image developer according to the exemplary embodiment.

The image forming apparatus according to the exemplary embodiment uses an image forming method (image forming method according to the exemplary embodiment) including charging the surface of the image holding member; forming an electrostatic image on the charged surface of the image holding member; developing the electrostatic image formed on the surface of the image holding member with the electrostatic image developer according to the exemplary embodiment to form a toner image; transferring the toner image formed on the surface of the image holding member onto the surface of a recording medium; and fixing the toner image onto the surface of the recording medium.

The image forming apparatus according to the exemplary embodiment may be any image forming apparatus known in the related art, such as a direct-transfer image forming apparatus in which a toner image formed on the surface of an image holding member is directly transferred to a recording medium; an intermediate-transfer image forming apparatus in which a toner image formed on the surface of an image holding member is transferred onto the surface of an intermediate transfer body in the first transfer step and the toner image transferred on the surface of the intermediate transfer body is transferred onto the surface of a recording medium in the second transfer step; an image forming apparatus including a cleaning unit that cleans the surface of the image holding member subsequent to the transfer of the toner image before the image holding member is again charged; and an image forming apparatus including a static-erasing unit that erases static by irradiating the surface of an image holding member with static-erasing light subsequent to the transfer of the toner image before the image holding member is again charged.

In the case where the image forming apparatus according to this exemplary embodiment is the intermediate-transfer image forming apparatus, the transfer unit may be constituted by, for example, an intermediate transfer body to which a toner image is transferred, a first transfer subunit that transfers a toner image formed on the surface of the image holding member onto the surface of the intermediate transfer body in the first transfer step, and a second transfer subunit that transfers the toner image transferred on the surface of the intermediate transfer body onto the surface of a recording medium in the second transfer step.

In the image forming apparatus according to the exemplary embodiment, for example, a portion including the developing unit may have a cartridge structure (i.e., process cartridge) detachably attachable to the image forming apparatus. An example of the process cartridge is a process cartridge including the electrostatic image developer according to the exemplary embodiment and the developing unit.

An example of the image forming apparatus according to the exemplary embodiment is described below, but the image forming apparatus is not limited thereto. Hereinafter, only components illustrated in drawings are described; others are omitted.

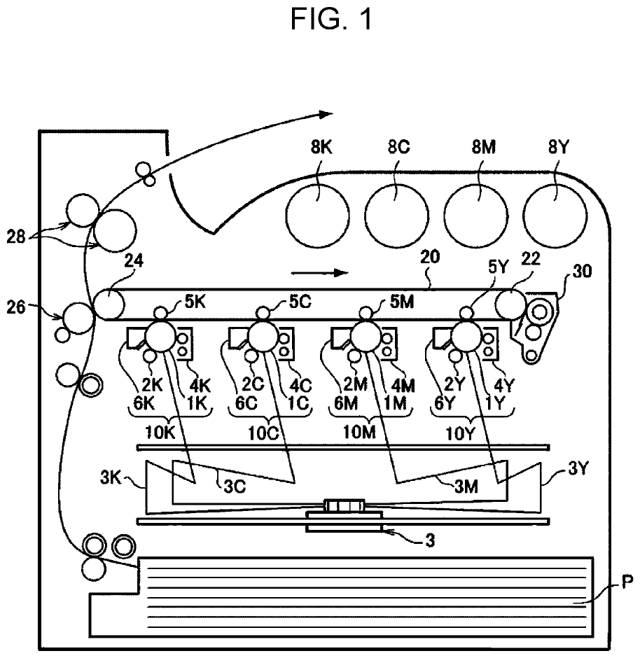

FIG. 1 schematically illustrates the image forming apparatus according to the exemplary embodiment.

The image forming apparatus illustrated in FIG. 1 includes first to fourth electrophotographic image formation units 10Y, 10M, 10C, and 10K that form yellow (Y), magenta (M), cyan (C), and black (K) images, respectively, on the basis of color separation image data. The image formation units (hereinafter, referred to simply as “units”) 10Y, 10M, 10C, and 10K are horizontally arranged in parallel at a predetermined distance from one another. The units 10Y, 10M, 10C, and 10K may be process cartridges detachably attachable to the image forming apparatus.

An intermediate transfer belt 20 that serves as an intermediate transfer body runs above (in FIG. 1) and extends over the units 10Y, 10M, 10C, and 10K. The intermediate transfer belt 20 is wound around a drive roller 22 and a support roller 24 arranged to contact with the inner surface of the intermediate transfer belt 20, which are spaced from each other in a direction from left to right in FIG. 1, and runs clockwise in FIG. 1, that is, in the direction from the first unit 10Y to the fourth unit 10K. Using a spring or the like (not illustrated), a force is applied to the support roller 24 in a direction away from the drive roller 22, thereby applying tension to the intermediate transfer belt 20 wound around the drive roller 22 and the support roller 24. An intermediate transfer body-cleaning device 30 is disposed so as to contact with the image-carrier-side surface of the intermediate transfer belt 20 and to face the drive roller 22.

Developing devices (i.e., developing units) 4Y, 4M, 4C, and 4K of the units 10Y, 10M, 10C, and 10K are supplied with yellow, magenta, cyan, and black toners stored in toner cartridges 8Y, 8M, 8C, and 8K, respectively.

Since the first to fourth units 10Y, 10M, 10C, and 10K have the same structure and the same action, the following description is made with reference to, as a representative, the first unit 10Y that forms an yellow image and is located upstream in a direction in which the intermediate transfer belt runs. Note that components of the second to fourth units 10M, 10C, and 10K which are equivalent to the above-described components of the first unit 10Y are denoted with reference numerals including magenta (M), cyan (C), or black (K) instead of yellow (Y), and the descriptions of the second to fourth units 10M, 10C, and 10K are omitted.

The first unit 10Y includes a photosensitive member 1Y serving as an image holding member. The following components are disposed around the photosensitive member 1Y sequentially in the counterclockwise direction: a charging roller (example of the charging unit) 2Y that charges the surface of the photosensitive member 1Y at a predetermined potential; an exposure device (example of the electrostatic image formation unit) 3 that forms an electrostatic image by irradiating the charged surface of the photosensitive member 1Y with a laser beam 3Y based on a color separated image signal; a developing device (example of the developing unit) 4Y that develops the electrostatic image by supplying a charged toner to the electrostatic image; a first transfer roller (example of the first transfer subunit) 5Y that transfers the developed toner image to the intermediate transfer belt 20; and a photosensitive-member cleaning device (example of the cleaning unit) 6Y that removes a toner remaining on the surface of the photosensitive member 1Y after the first transfer.

The first transfer roller 5Y is disposed so as to contact with the inner surface of the intermediate transfer belt 20 and to face the photosensitive member 1Y. Each of the first transfer rollers 5Y, 5M, 5C, and 5K is connected to a bias power supply (not illustrated) that applies a first transfer bias to the first transfer rollers. Each bias power supply varies the transfer bias applied to the corresponding first transfer roller on the basis of the control by a controller (not illustrated).

The action of forming a yellow image in the first unit 10Y is described below.

Before the action starts, the surface of the photosensitive member 1Y is charged at a potential of −600 to −800 V by the charging roller 2Y.

The photosensitive member 1Y is formed by stacking a photosensitive layer on a conductive substrate (e.g., volume resistivity at 20° C.: 1×10⁻⁶ Ωcm or less). The photosensitive layer is normally of high resistance (comparable with the resistance of ordinary resins), but, upon being irradiated with the laser beam 3Y, the specific resistance of the portion irradiated with the laser beam varies. Thus, the exposure device 3 irradiates the surface of the charged photosensitive member 1Y with the laser beam 3Y on the basis of the image data of the yellow image sent from the controller (not illustrated). The laser beam 3Y is impinged on the photosensitive layer formed in the surface of the photosensitive member 1Y. As a result, an electrostatic image of yellow image pattern is formed on the surface of the photosensitive member 1Y.

The term “electrostatic image” used herein refers to an image formed on the surface of the photosensitive member 1Y by charging, the image being a “negative latent image” formed by irradiating a portion of the photosensitive layer with the laser beam 3Y to reduce the specific resistance of the irradiated portion such that the charges on the irradiated surface of the photosensitive member 1Y discharge while the charges on the portion that is not irradiated with the laser beam 3Y remain.

The electrostatic image, which is formed on the photosensitive member 1Y as described above, is sent to the predetermined developing position by the rotating photosensitive member 1Y. The electrostatic image on the photosensitive member 1Y is visualized (i.e., developed) in the form of a toner image by the developing device 4Y at the developing position.

The developing device 4Y includes an electrostatic image developer including, for example, at least, a yellow toner and a carrier. The yellow toner is stirred in the developing device 4Y to be charged by friction and supported on a developer roller (example of the developer support), carrying an electric charge of the same polarity (i.e., negative) as the electric charge generated on the photosensitive member 1Y. The yellow toner is electrostatically adhered to the erased latent image portion on the surface of the photosensitive member 1Y as the surface of the photosensitive member 1Y passes through the developing device 4Y. Thus, the latent image is developed using the yellow toner. The photosensitive member 1Y on which the yellow toner image is formed keeps rotating at the predetermined rate, thereby transporting the toner image developed on the photosensitive member 1Y to the predetermined first transfer position.

Upon the yellow toner image on the photosensitive member 1Y reaching the first transfer position, first transfer bias is applied to the first transfer roller 5Y so as to generate an electrostatic force on the toner image in the direction from the photosensitive member 1Y toward the first transfer roller 5Y. Thus, the toner image on the photosensitive member 1Y is transferred to the intermediate transfer belt 20. The transfer bias applied has the opposite polarity (+) to that of the toner (−) and controlled to be, for example, in the first unit 10Y, +10 μA by a controller (not illustrated).

The toner particles remaining on the photosensitive member 1Y are removed by the photosensitive-member cleaning device 6Y and then collected.

Each of the first transfer biases applied to first transfer rollers 5M, 5C, and 5K of the second, third, and fourth units 10M, 10C, and 10K is controlled in accordance with the first unit 10Y.

Thus, the intermediate transfer belt 20, on which the yellow toner image is transferred in the first unit 10Y, is successively transported through the second to fourth units 10M, 10C, and 10K while toner images of the respective colors are stacked on top of another.

The resulting intermediate transfer belt 20 on which toner images of four colors are multiple-transferred in the first to fourth units is then transported to a second transfer section including a support roller 24 contacting with the inner surface of the intermediate transfer belt 20 and a second transfer roller (example of the second transfer subunit) 26 disposed on the image-carrier-side of the intermediate transfer belt 20. A recording paper (example of the recording medium) P is fed by a feed mechanism into a narrow space between the second transfer roller 26 and the intermediate transfer belt 20 that contact with each other at the predetermined timing. The second transfer bias is then applied to the support roller 24. The transfer bias applied here has the same polarity (−) as that of the toner (−) and generates an electrostatic force on the toner image in the direction from the intermediate transfer belt 20 toward the recording paper P. Thus, the toner image on the intermediate transfer belt 20 is transferred to the recording paper P. The intensity of the second transfer bias applied is determined on the basis of the resistance of the second transfer section which is detected by a resistance detector (not illustrated) that detects the resistance of the second transfer section and controlled by changing voltage.

Subsequently, the recording paper P is transported into a nip part of the fixing device (example of the fixing unit) 28 at which a pair of fixing rollers contact with each other. The toner image is fixed to the recording paper P to form a fixed image.

Examples of the recording paper P to which a toner image is transferred include plain paper used in electrophotographic copiers, printers, and the like. Instead of the recording paper P, OHP films and the like may be used as a recording medium.

The surface of the recording paper P may be smooth in order to enhance the smoothness of the surface of the fixed image. Examples of such a recording paper include coated paper produced by coating the surface of plain paper with resin or the like and art paper for printing.

The recording paper P, to which the color image has been fixed, is transported toward an exit portion. Thus, the series of the steps for forming a color image are terminated.

Process Cartridge and Toner Cartridge

A process cartridge according to the exemplary embodiment is described below.

The process cartridge according to the exemplary embodiment includes a developing unit that includes the electrostatic image developer according to the exemplary embodiment and develops an electrostatic image formed on the surface of an image holding member with the electrostatic image developer to form a toner image. The process cartridge according to the exemplary embodiment is detachably attachable to an image forming apparatus.

The structure of the process cartridge according to the exemplary embodiment is not limited to the above-described one. The process cartridge according to the exemplary embodiment may further include, in addition to the developing device, at least one unit selected from an image holding member, a charging unit, an electrostatic image formation unit, a transfer unit, etc.

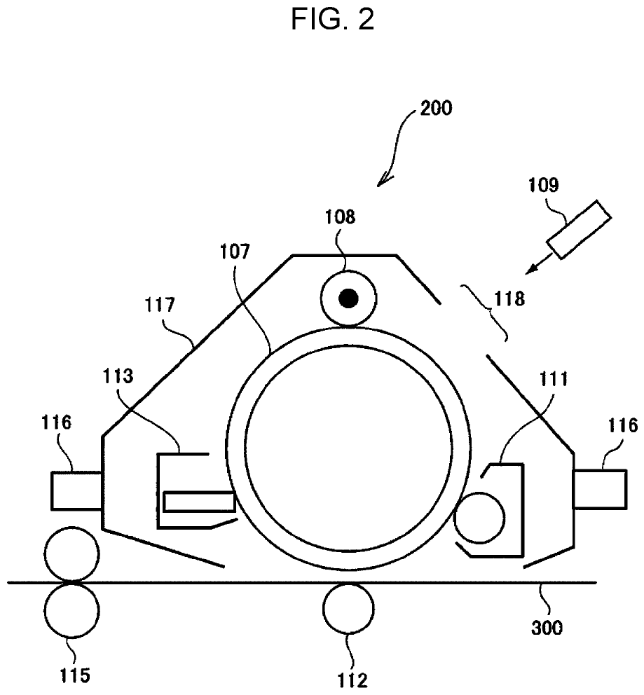

An example of the process cartridge according to the exemplary embodiment is described below, but the process cartridge is not limited thereto. Hereinafter, only components illustrated in FIG. 2 are described; others are omitted.

FIG. 2 schematically illustrates the process cartridge according to the exemplary embodiment.

A process cartridge 200 illustrated in FIG. 2 includes, for example, a photosensitive member 107 (example of the image holding member), a charging roller 108 (example of the charging unit) disposed on the periphery of the photosensitive member 107, a developing device 111 (example of the developing unit), and a photosensitive-member cleaning device 113 (example of the cleaning unit), which are combined into one unit using a housing 117 to form a cartridge. The housing 117 has an aperture 118 for exposure. A mounting rail 116 is disposed on the housing 117.

In FIG. 2, Reference numeral 109 denotes an exposure device (example of the electrostatic image formation unit), Reference numeral 112 denotes a transfer device (example of the transfer unit), Reference numeral 115 denotes a fixing device (example of the fixing unit), and the Reference numeral 300 denotes recording paper (example of the recording medium).

A toner cartridge according to the exemplary embodiment is described below.

The toner cartridge according to the exemplary embodiment is a toner cartridge that includes the toner according to the exemplary embodiment and is detachably attachable to an image forming apparatus. The toner cartridge includes a replenishment toner that is to be supplied to the developing unit disposed inside an image forming apparatus.

The image forming apparatus illustrated in FIG. 1 is an image forming apparatus that includes the toner cartridges 8Y, 8M, 8C, and 8K detachably attached to the image forming apparatus. Each of the developing devices 4Y, 4M, 4C, and 4K is connected to a specific one of the toner cartridges which corresponds to the color of the developing device with a toner supply pipe (not illustrated). When the amount of toner contained in a toner cartridge is small, the toner cartridge is replaced.

### EXAMPLES

Examples are described below. It should be noted that the exemplary embodiments of the present disclosure are not limited by Examples. Hereinafter, all “part” and “%” are on a mass basis unless otherwise specified.

Preparation of Specific Resin Particle Dispersion Liquids and Comparative Resin Particle Dispersion Liquids

Preparation of Specific Resin Particle Dispersion Liquid 1
Styrene: 47.9 parts
n-Butyl acrylate: 51.8 parts
2-Carboxyethyl acrylate: 0.3 parts
Anionic surfactant (“Dowfax2A1” produced by The Dow Chemical Company): 0.8 parts
1,10-Decanediol diacrylate: 1.65 parts

The above raw materials are mixed with one another to form a solution. To the solution, 60 parts of ion-exchange water is added. Then, dispersion and emulsification are performed in a flask. Hereby, an emulsion is prepared.

Subsequently, 1.3 parts of an anionic surfactant (“Dowfax2A1” produced by The Dow Chemical Company) is dissolved in 90 parts of ion-exchange water, and 1 part of the emulsion is added to the resulting solution. To the solution, 10 parts of ion-exchange water containing 5.4 parts of ammonium persulfate dissolved therein is further charged.

Then, the remaining part of the emulsion is charged into the flask over 180 minutes. After the inside of the flask has been purged with nitrogen, while the solution contained in the flask is stirred, the temperature is increased to 65° C. in an oil bath. Subsequently, emulsion polymerization is continued for 500 minutes. Then, a specific resin particle dispersion liquid 1 the solid content of which has been adjusted to 24.5% by mass is prepared.

Preparation of Specific Resin Particle Dispersion Liquids 2 to 14 and C1 and C2

Specific Resin Particle Dispersion Liquids 2 to 14 and C1 and C2 are prepared as in the preparation of the specific resin particle dispersion liquid 1, except that the amounts of styrene, n-butyl acrylate, acrylic acid, and 2-carboxyethyl acrylate added, the total amount of the anionic surfactant added, the amount of the crosslinking agent added, the type of the crosslinking agent (in Table 1, “Type of crosslinking agent”), the amount of the ammonium persulfate added, the temperature at which heating is performed with an oil bath (in Table 1, “Polymerization temperature”), the amount of time during which the remaining part of the emulsion is charged (in Table 1, “Addition time”), and the amount of time during which the emulsion polymerization is continued after heating (in Table 1, “Holding time”) are changed as listed in Table 1.

Table 1 also lists the number of carbon atoms included in the alkylene chain of the crosslinking agent added (in Table 1, “Number of carbon atoms”).

TABLE 1

| | Materials | | | | | Crosslinking agent | | | | | | |
|---|---|---|---|---|---|---|---|---|---|---|---|---|
| Resin | | | | 2- | | | | Number | Composition | | | |
| particle | | n-Butyl | Acrylic | Carboxyethyl | Anionic | Amount | Type of | of | Ammonium | Polymerization | Addition | Holding |
| dispersion | Styrene | acrylate | acid | acrylate | surfactant | added | crosslinking | carbon | persulfate | temperature | time | time |
| liquid | Parts | Parts | Parts | Parts | Parts | Parts | agent | atoms | Parts | ° C. | min | min |
| 1 | 47.9 | 51.8 | 0 | 0.3 | 2.1 | 1.65 | 1,10- | 10 | 5.4 | 65 | 180 | 500 |
| | | | | | | | Decanediol | | | | | |
| | | | | | | | diacrylate | | | | | |
| 2 | 54.5 | 44.6 | 0 | 0.84 | 1.26 | 1.65 | 1,10- | 10 | 5.4 | 65 | 180 | 500 |
| | | | | | | | Decanediol | | | | | |
| | | | | | | | diacrylate | | | | | |
| 3 | 34.8 | 64.1 | 0 | 0.84 | 1.26 | 1.65 | 1,10- | 10 | 5.4 | 65 | 180 | 500 |
| | | | | | | | Decanediol | | | | | |
| | | | | | | | diacrylate | | | | | |
| 4 | 47.9 | 51.8 | 0 | 0.3 | 2.5 | 1.65 | 1,10- | 10 | 11.2 | 75 | 180 | 350 |
| | | | | | | | Decanediol | | | | | |
| | | | | | | | diacrylate | | | | | |
| 5 | 47.9 | 51.8 | 0 | 0.3 | 2.3 | 3.1 | 1,10- | 10 | 6.1 | 65 | 180 | 500 |
| | | | | | | | Decanediol | | | | | |
| | | | | | | | diacrylate | | | | | |
| 6 | 47.9 | 51.8 | 0 | 0.3 | 1.2 | 1.65 | 1,10- | 10 | 5.4 | 65 | 180 | 500 |
| | | | | | | | Decanediol | | | | | |
| | | | | | | | diacrylate | | | | | |
| 7 | 47.9 | 51.8 | 0 | 0.3 | 2.9 | 1.65 | 1,10- | 10 | 5.4 | 65 | 180 | 500 |
| | | | | | | | Decanediol | | | | | |
| | | | | | | | diacrylate | | | | | |
| 8 | 47.9 | 51.8 | 0 | 0.3 | 1 | 1.65 | 1,10- | 10 | 5.4 | 65 | 180 | 500 |
| | | | | | | | Decanediol | | | | | |
| | | | | | | | diacrylate | | | | | |
| 9 | 47.9 | 51.8 | 0 | 0.3 | 3.1 | 1.65 | 1,10- | 10 | 5.4 | 65 | 180 | 500 |
| | | | | | | | Decanediol | | | | | |
| | | | | | | | diacrylate | | | | | |
| 10 | 46.8 | 48.9 | 2 | 0.3 | 2.1 | 1.65 | 1,10- | 10 | 5.4 | 65 | 180 | 500 |
| | | | | | | | Decanediol | | | | | |
| | | | | | | | diacrylate | | | | | |
| 11 | 47.9 | 51.8 | 0 | 0.84 | 1.26 | 1.65 | 1,6- | 6 | 5.4 | 65 | 180 | 500 |
| | | | | | | | Hexanediol | | | | | |
| | | | | | | | diacrylate | | | | | |
| 12 | 47.9 | 51.8 | 0 | 0.84 | 1.26 | 1.65 | 1,4- | 4 | 5.4 | 65 | 180 | 500 |
| | | | | | | | Butanediol | | | | | |
| | | | | | | | diacrylate | | | | | |
| C1 | 53.8 | 45.9 | 0 | 0.3 | 2.1 | 0.36 | 1,10- | 10 | 11 | 75 | 120 | 300 |
| | | | | | | | Decanediol | | | | | |
| | | | | | | | diacrylate | | | | | |
| C2 | 42.9 | 56.8 | 0 | 0.3 | 1.8 | 0.67 | 1,10- | 10 | 5.7 | 60 | 240 | 700 |
| | | | | | | | Decanediol | | | | | |
| | | | | | | | diacrylate | | | | | |
| 13 | 56.8 | 42.6 | 0 | 0.84 | 1.26 | 1.65 | 1,10- | 10 | 5.4 | 65 | 180 | 500 |
| | | | | | | | Decanediol | | | | | |
| | | | | | | | diacrylate | | | | | |
| 14 | 30.8 | 69.1 | 0 | 0.84 | 1.26 | 1.65 | 1,10- | 10 | 5.4 | 65 | 180 | 500 |
| | | | | | | | Decanediol | | | | | |
| | | | | | | | diacrylate | | | | | |

Table 2 lists the glass transition temperature Tg of the resin particles include in each of the specific resin particle dispersion liquids and the comparative resin particle dispersion liquids which is determined by measurement of dynamic viscoelasticity (in Table 2, “Tg”), the minimum and maximum values of the storage modulus G′(p90-150) of the resin particles at 90° C. or more and 150° C. or less (in Table 2, “G′(min 90-150°) C.” and “G′(max 90-150°) C”, respectively), the minimum and maximum values of the loss tangent tan δ of the resin particles at 30° C. or more and 150° C. or less (in Table 2, “tan δ(min)” and “tan δ(max)”, respectively), the minimum and maximum values of the loss tangent tan δ of the resin particles at 65° C. or more and 150° C. or less (in Table 2, “tan δ(min 65-150°) C.” and “tan δ(max 65-150°) C”, respectively), the number average size of the resin particles (in Table 2, “Number average size”), and the SP (S) of the resin particles, which are determined by the above-described methods.

TABLE 2

| Resin | | G′(min) | G′(max) | | | tanδ | tanδ | Number | |
|---|---|---|---|---|---|---|---|---|---|
| particle | | 90- | 90- | | | (min) | (max) | average | SP |
| dispersion | Tg | 150° C. | 150° C. | tanδ | tanδ | 65- | 65- | size | value |
| liquid | ° C. | Pa | Pa | (min) | (max) | 150° C. | 150° C. | nm | (S) |
| 1 | 32.1 | 2.6 × 10⁵ | 5.1 × 10⁵ | 0.028 | 2.35 | 0.028 | 0.203 | 153 | 9.07 |
| 2 | 44.3 | 3.8 × 10⁵ | 5.9 × 10⁵ | 0.028 | 2.41 | 0.028 | 0.411 | 163 | 9.09 |
| 3 | 12.5 | 3.3 × 10⁵ | 5.7 × 10⁵ | 0.029 | 2.49 | 0.029 | 0.237 | 159 | 9.01 |
| 4 | 29.8 | 2.7 × 10⁵ | 6.1 × 10⁵ | 0.043 | 2.45 | 0.043 | 0.401 | 112 | 9.07 |
| 5 | 23.7 | 3.1 × 10⁵ | 5.8 × 10⁵ | 0.014 | 2.37 | 0.014 | 0.189 | 135 | 9.07 |
| 6 | 32.4 | 2.8 × 10⁵ | 5.9 × 10⁵ | 0.031 | 2.29 | 0.031 | 0.245 | 291 | 9.07 |
| 7 | 32.1 | 2.7 × 10⁵ | 6.2 × 10⁵ | 0.033 | 2.31 | 0.033 | 0.239 | 64 | 9.07 |
| 8 | 32.5 | 3.0 × 10⁵ | 7.1 × 10⁵ | 0.029 | 2.32 | 0.029 | 0.226 | 305 | 9.07 |
| 9 | 32.8 | 3.0 × 10⁵ | 7.1 × 10⁵ | 0.034 | 2.36 | 0.034 | 0.228 | 57 | 9.07 |
| 10 | 31.5 | 2.7 × 10⁵ | 7.2 × 10⁵ | 0.031 | 2.39 | 0.031 | 0.214 | 162 | 9.13 |
| 11 | 34.1 | 3.6 × 10⁵ | 5.8 × 10⁵ | 0.029 | 2.25 | 0.028 | 0.197 | 165 | 9.07 |
| 12 | 35.2 | 4.6 × 10⁵ | 6.6 × 10⁵ | 0.021 | 2.29 | 0.021 | 0.189 | 159 | 9.07 |
| C1 | 39.8 | 2.9 × 10⁵ | 6.9 × 10⁵ | 0.026 | 2.45 | 0.026 | 0.221 | 165 | 9.10 |
| C2 | 22.6 | 3.4 × 10⁵ | 6.3 × 10⁵ | 0.090 | 2.32 | 0.033 | 0.631 | 190 | 9.09 |
| 13 | 46.5 | 4.8 × 10⁵ | 6.8 × 10⁵ | 0.026 | 2.36 | 0.028 | 0.513 | 154 | 9.12 |
| 14 | 9.4 | 3.3 × 10⁵ | 5.8 × 10⁵ | 0.031 | 2.38 | 0.027 | 0.226 | 171 | 8.98 |

Preparation of Amorphous Resin Particle Dispersion Liquid 1
Terephthalic acid: 28 parts
Fumaric acid: 164 parts
Adipic acid: 10 parts
Bisphenol A ethylene oxide 2-mol adduct: 26 parts
Bisphenol A propylene oxide 2-mol adduct: 542 parts

The above materials are charged into a reactor equipped with a stirring device, a nitrogen introduction tube, a temperature sensor, and a fractionating column. The temperature is increased to 190° C. over 1 hour. To 100 parts of the above materials, 1.2 parts of dibutyltin oxide is added. While the product water is distilled away, the temperature is increased to 240° C. over 6 hours. While the temperature is maintained at 240° C., the dehydration condensation reaction is continued for 3 hours. Then, the reaction product is cooled.

While the reaction product is in a molten state, it is transferred to “CAVITRON CD1010” (produced by EUROTEC) at a rate of 100 g/min. Simultaneously, a 0.37-mass % ammonia water prepared separately is transferred to CAVITRON CD1010 at a rate of 0.1 L/min while being heated at 120° C. with a heat exchanger. CAVITRON CD1010 is operated with a rotor rotation speed of 60 Hz and a pressure of 5 kg/cm². Hereby, a resin particle dispersion liquid in which amorphous polyester resin particles having a volume average size of 169 nm are dispersed is prepared. Then, ion-exchange water is added to the resin particle dispersion liquid in order to adjust the solid content to 20% by mass. Hereby, an amorphous resin particle dispersion liquid 1 is prepared.

The amorphous polyester resin has an SP (R) of 9.41.

Preparation of Amorphous Resin Particle Dispersion Liquid 2
Styrene: 72 parts
n-Butyl acrylate: 27 parts
2-Carboxyethyl acrylate: 1.3 parts
Dodecanethiol: 2 parts

The above materials are mixed with one another to form a liquid mixture. In a flask, the liquid mixture is dispersed in a surfactant solution prepared by dissolving 1.2 parts by mass of an anionic surfactant (TaycaPower, produced by TAYCA CORPORATION) in 100 parts by mass of ion-exchange water, and emulsification is performed. Subsequently, while the inside of the flask is stirred, an aqueous solution prepared by dissolving 6 parts by mass of ammonium persulfate in 50 parts by mass of ion-exchange water is charged into the flask over 20 minutes. Then, after nitrogen purging has been performed, while the inside of the flask is stirred, heating is performed in an oil bath until the temperature of the contents reaches 75° C. While the temperature is maintained at 75° C. for 4 hours, emulsion polymerization is continued. Hereby, a resin particle dispersion liquid in which amorphous styrene acrylic resin particles having a volume average size of 160 nm and a weight average molecular weight of 56000 are dispersed is prepared. Then, ion-exchange water is added to the resin particle dispersion liquid in order to adjust the solid content to 31.4% by mass. Hereby, an amorphous resin particle dispersion liquid 2 is prepared.

The amorphous styrene acrylic resin has an SP (R) of 9.14.

Preparation of Amorphous Resin Particle Dispersion Liquid 3
Terephthalic acid: 28 parts
Fumaric acid: 174 parts
Bisphenol A ethylene oxide 2-mol adduct: 26 parts
Bisphenol A propylene oxide 2-mol adduct: 542 parts

The above materials are charged into a reactor equipped with a stirring device, a nitrogen introduction tube, a temperature sensor, and a fractionating column. The temperature is increased to 190° C. over 1 hour. To 100 parts of the above materials, 1.2 parts of dibutyltin oxide is added. While the product water is distilled away, the temperature is increased to 240° C. over 6 hours. While the temperature is maintained at 240° C., the dehydration condensation reaction is continued for 3 hours. Then, the reaction product is cooled.

While the reaction product is in a molten state, it is transferred to “CAVITRON CD1010” (produced by EUROTEC) at a rate of 100 g/min. Simultaneously, a 0.37-mass % ammonia water prepared separately is transferred to CAVITRON CD1010 at a rate of 0.1 L/min while being heated at 120° C. with a heat exchanger. CAVITRON CD1010 is operated with a rotor rotation speed of 60 Hz and a pressure of 5 kg/cm². Hereby, a resin particle dispersion liquid in which amorphous polyester resin particles having a volume average size of 175 nm are dispersed is prepared. Then, ion-exchange water is added to the resin particle dispersion liquid in order to adjust the solid content to 20% by mass. Hereby, an amorphous resin particle dispersion liquid 3 is prepared.

The amorphous polyester resin has an SP (R) of 9.43.

Preparation of Crystalline Resin Particle Dispersion Liquid
1,10-Dodecanedioic acid: 225 parts
1,6-Hexanediol: 143 parts

The above materials are charged into a reactor equipped with a stirring device, a nitrogen introduction tube, a temperature sensor, and a fractionating column. The temperature is increased to 160° C. over 1 hour. To the reactor, 0.8 parts by mass of dibutyltin oxide is added. While the product water is distilled away, the temperature is increased to 180° C. over 6 hours. While the temperature is maintained at 180° C., the dehydration condensation reaction is continued for 5 hours. Subsequently, the temperature is gradually increased to 230° C. under reduced pressure. While the temperature is maintained at 230° C., stirring is performed for 2 hours. Then, the reaction product is cooled. After cooling, solid-liquid separation is performed to dry the solid substance. Hereby, a crystalline polyester resin is prepared.
Crystalline polyester resin: 100 parts
Methyl ethyl ketone: 40 parts
Isopropyl alcohol: 30 parts
10% Aqueous ammonia solution: 6 parts

The above materials are charged into a jacketed 3-liter reaction tank (“BJ-30N” produced by TOKYO RIKAKIKAI CO, LTD.) equipped with a condenser, a thermometer, a water dropper, and an anchor impeller. While the temperature is maintained at 80° C. with a water circulation thermostat, the resin is dissolved by performing stirring at 100 rpm. Then, the temperature of the water circulation thermostat is set to 50° C., and 400 parts of ion-exchange water maintained at 50° C. is added dropwise at a rate of 7 mass part/min in total in order to perform phase inversion. Hereby, an emulsion is prepared. Into a 2-liter eggplant flask, 576 parts by mass of the emulsion and 500 parts by mass of ion-exchange water are charged. The eggplant flask is connected to an evaporator (produced by TOKYO RIKAKIKAI CO, LTD.) equipped with a vacuum control unit with a trap ball interposed therebetween. While the eggplant flask is rotated, the temperature is increased in a hot-water bath at 60° C. With attention to bumping, the pressure is reduced to 7 kPa to remove the solvent. The volume average size D50v of the resin particles included in the dispersion liquid is 185 nm. Subsequently, ion-exchange water is added to the dispersion liquid. Hereby, a crystalline resin particle dispersion liquid having a solid content of 22.1% is prepared.

Preparation of Colorant Dispersion Liquid
Cyan pigment (Pigment Blue 15:3 (copper phthalocyanine) produced by Dainichiseika Color & Chemicals Mfg. Co., Ltd.): 98 parts
Anionic surfactant (TaycaPower produced by TAYCA CORPORATION): 2 parts
Ion-exchange water: 420 parts

The above materials are mixed with one another to form a solution, which is dispersed for 10 minutes with a homogenizer (IKA ULTRA-TURRAX). Hereby, a colorant dispersion liquid having a median particle size of 164 nm and a solid content of 21.1% by mass is prepared.

Preparation of Release Agent Dispersion Liquid
Synthetic wax (FNP92 produced by Nippon Seiro Co., Ltd., melting temperature Tw: 92° C.): 50 parts
Anionic surfactant (TaycaPower produced by TAYCA CORPORATION): 1 part
Ion-exchange water: 200 parts

The above materials are mixed with one another, and the resulting mixture is heated to 130° C. and dispersed with a homogenizer (“ULTRA-TURRAX T50” produced by IKA). Further dispersion treatment is performed with a Manton-Gaulin high pressure homogenizer (produced by Gaulin). Hereby, a release agent dispersion liquid (solid content: 20% by mass) in which release agent particles are dispersed is prepared. The release agent particles have a volume average size of 214 nm.

### Example 1

Amorphous resin particle dispersion liquid 1: 169 parts
Specific resin particle dispersion liquid 1: 33 parts
Crystalline resin particle dispersion liquid: 53 parts
Release agent dispersion liquid: 25 parts
Colorant dispersion liquid: 33 parts
Anionic surfactant (“Dowfax2A1” produced by The Dow Chemical Company): 4.8 parts

After the liquid temperatures of above raw materials have been adjusted to 10° C., they are charged into a 3-liter cylindrical stainless steel container. The resulting mixture is stirred by performing dispersion for 2 minutes with a shearing force being applied using a homogenizer (ULTRA-TURRAX T50″ produced by IKA) at 4000 rpm.

Subsequently, 1.75 parts of a 10% nitric acid solution of aluminum sulfate is gradually added dropwise to the mixture as a coagulant. Then, stirring is performed by performing dispersion for 10 minutes with the rotation speed of the homogenizer being 10000 rpm. Hereby, a raw material dispersion liquid is prepared.

Subsequently, the raw material dispersion liquid is transferred to a polymerization vessel equipped with a stirring device having a twin paddle stirring impeller and a thermometer. Heating is started using a heating mantle with a stirrer rotation speed being 550 rpm. The growth of the aggregated particles is promoted at 40° C. In this step, the pH of the raw material dispersion liquid is controlled to fall within the range of 2.2 to 3.5 using a 0.3-M aqueous nitric acid solution and a 1-M aqueous sodium hydroxide solution. Holding is performed about 2 hours within the above pH range to form aggregated particles.

Subsequently, a dispersion liquid prepared by mixing 21 parts of the amorphous resin particle dispersion liquid 1 with 8 parts of the specific resin particle dispersion liquid 1 is further added. Then, holding is performed for 60 minutes to cause the binder resin particles and the specific resin particles to adhere onto the surfaces of the aggregated particles. Subsequently, the temperature is increased to 53° C. and 21 parts of the amorphous resin particle dispersion liquid 1 is further added. Then, holding is performed for 60 minutes to cause the binder resin particles to adhere onto the surfaces of the aggregated particles.

The aggregated particles are adjusted while the sizes and forms of the particles are confirmed with an optical microscope and MULTISIZER 3. Subsequently, pH is adjusted to 7.8 using a 5% aqueous sodium hydroxide solution, and holding is performed for 15 minutes.

Then, pH is increased to 8.0 and the temperature is increased to 85° C. in order to cause fusion of the aggregated particles. At two hours after the fusion of the aggregated particles has been confirmed with an optical microscope, heating is stopped and cooling is performed at a cooling rate of 1.0° C./min. Subsequently, screening is performed through a 20-μm mesh, washing with water is repeatedly performed, and then drying is performed with a vacuum dryer. Hereby, toner particles 1 having a volume average size of 5.3 μm are prepared.

With 100 parts of the toner particles, 0.7 parts of silica particles treated with a dimethyl silicone oil (“RY200” produced by Nippon Aerosil Co., Ltd.) are mixed using a Henschel mixer. Hereby, a toner 1 is prepared.

### Examples 2 to 11, Examples 29 to 32, and Comparative Examples C1 and C2

Toners 2 to 11, toners 29 to 32, and toners C1 and C2 are each prepared as in the preparation of the toner 1, except that one of the specific resin particle dispersion liquids and comparative resin particle dispersion liquids listed in Table 3 is used instead of the specific resin particle dispersion liquid 1 such that the content of the resin particles (i.e., specific resin particles or comparative resin particles) relative to the total amount of the entire toner particles is as described in Table 3.

### Example 12

A toner 12 is prepared as in the preparation of the toner 1, except that the amount of the specific resin particle dispersion liquid 1 used is changed such that the content of the specific resin particles relative to the total amount of the entire toner particles is as described in Table 3, and the amount of the crystalline resin particle dispersion liquid added is adjusted such that the content of the crystalline resin relative to the total amount of the entire binder resin is as described in Table 3.

### Example 13

A toner 13 is prepared as in the preparation of the toner 1, except that the amount of the crystalline resin particle dispersion liquid added is adjusted such that the content of the crystalline resin relative to the total amount of the entire binder resin is as described in Table 3.

### Example 14

A toner 14 is prepared as in the preparation of the toner 1, except that one of the specific resin particle dispersion liquids and comparative resin particle dispersion liquids listed in Table 3 is used instead of the specific resin particle dispersion liquid 1 such that the content of the resin particles (i.e., specific resin particles or comparative resin particles) relative to the total amount of the entire toner particles is as described in Table 3, and the crystalline resin particle dispersion liquid is not added.

### Examples 15 and 28

Toners 15 and 28 are prepared as in the preparation of the toner 1, except that the amorphous resin particle dispersion liquid described in Table 3 is used in the amount described in Table 3 instead of using the amorphous resin particle dispersion liquid 1.

### Example 16

A toner 16 is prepared as in the preparation of the toner 1, except that the rotation speed of the homogenizer is changed from 10000 rpm to 5000 rpm.

### Example 17

A toner 17 is prepared as in the preparation of the toner 1, except that the amount of the crystalline resin particle dispersion liquid added is adjusted such that the content of the crystalline resin relative to the total amount of the entire binder resin is as described in Table 3.

### Example 18

A toner 18 is prepared as in the preparation of the toner 1, except that the amount of the specific resin particle dispersion liquid 1 used is changed such that the content of the specific resin particles relative to the total amount of the entire toner particles is as described in Table 3, and the amount of the crystalline resin particle dispersion liquid added is adjusted such that the content of the crystalline resin relative to the total amount of the entire binder resin is as described in Table 3.

### Example 19

A toner 19 is prepared as in the preparation of the toner 1, except that the pH at which the fusion of the aggregated particles is performed is changed from 8.0 to 9.0.

### Example 20

A toner 20 is prepared as in the preparation of the toner 1, except that the pH at which the fusion of the aggregated particles is performed is changed from 8.0 to 5.5.

### Example 21

A toner 21 is prepared as in the preparation of the toner 1, except that the amount of the specific resin particle dispersion liquid 1 used is changed such that the content of the specific resin particles relative to the total amount of the entire toner particles is as described in Table 3, and the pH at which the fusion of the aggregated particles is performed is changed from 8.0 to 9.5.

### Example 22

A toner 22 is prepared as in the preparation of the toner 1, except that the amount of the specific resin particle dispersion liquid 1 used is changed such that the content of the specific resin particles relative to the total amount of the entire toner particles is as described in Table 3, the amount of the specific resin particles 1 used is changed from 10 to 19, and the pH at which the fusion of the aggregated particles is performed is changed from 8.0 to 6.0.

### Examples 23 to 27

Toners 23 to 27 are each prepared as in the preparation of the toner 1, except that one of the specific resin particle dispersion liquids listed in table 3 is used instead of the specific resin particle dispersion liquid 1 in an amount such that the content of the specific resin particles relative to the total amount of the entire toner particles is as described in Table 3, and the amount of the crystalline resin particle dispersion liquid added is adjusted such that the content of the crystalline resin relative to the total amount of the entire binder resin is as described in Table 3.

### Comparative Example C3

Amorphous resin particle dispersion liquid 1: 169 parts
Specific resin particle dispersion liquid 1: 33 parts
Crystalline resin particle dispersion liquid: 53 parts
Release agent dispersion liquid: 25 parts
Colorant dispersion liquid: 33 parts
Anionic surfactant (“Dowfax2A1” produced by The Dow Chemical Company): 4.8 parts

After the liquid temperatures of above raw materials have been adjusted to 30° C., they are charged into a 3-liter cylindrical stainless steel container. The resulting mixture is stirred by performing dispersion for 2 minutes with a shearing force being applied using a homogenizer (ULTRA-TURRAX T50″ produced by IKA) at 4000 rpm.

Subsequently, 1.75 parts of a 10% nitric acid solution of aluminum sulfate is gradually added dropwise to the mixture as a coagulant. Then, stirring is performed by performing dispersion for 3 minutes with the rotation speed of the homogenizer being 4000 rpm. Hereby, a raw material dispersion liquid is prepared.

Subsequently, the raw material dispersion liquid is transferred to a polymerization vessel equipped with a stirring device having a twin paddle stirring impeller and a thermometer. Heating is started using a heating mantle with a stirrer rotation speed being 550 rpm. The growth of the aggregated particles is promoted at 40° C. In this step, the pH of the raw material dispersion liquid is controlled to fall within the range of 2.2 to 3.5 using a 0.3-M aqueous nitric acid solution and a 1-M aqueous sodium hydroxide solution. Holding is performed about 2 hours within the above pH range to form aggregated particles.

Subsequently, a dispersion liquid prepared by mixing 21 parts of the amorphous resin particle dispersion liquid 1 with 8 parts of the specific resin particle dispersion liquid 1 is further added. Then, holding is performed for 60 minutes to cause the binder resin particles and the specific resin particles to adhere onto the surfaces of the aggregated particles. Subsequently, the temperature is increased to 53° C. and 21 parts of the amorphous resin particle dispersion liquid is further added. Then, holding is performed for 60 minutes to cause the binder resin particles to adhere onto the surfaces of the aggregated particles.

The aggregated particles are adjusted while the sizes and forms of the particles are confirmed with an optical microscope and MULTISIZER 3.

Subsequently, pH is adjusted to 7.8 using a 5% aqueous sodium hydroxide solution, and holding is performed for 15 minutes. Then, pH is increased to 8.0 and the temperature is increased to 85° C. in order to cause fusion of the aggregated particles. At two hours after the fusion of the aggregated particles has been confirmed with an optical microscope, heating is stopped and cooling is performed at a cooling rate of 1.0° C./min. Subsequently, screening is performed through a 20-μm mesh, washing with water is repeatedly performed, and then drying is performed with a vacuum dryer. Hereby, toner particles C3 are prepared.

With 100 parts of the toner particles, 0.7 parts of silica particles treated with a dimethyl silicone oil (“RY200” produced by Nippon Aerosil Co., Ltd.) are mixed using a Henschel mixer. Hereby, a toner C3 is prepared.

### Comparative Example C4

Amorphous resin particle dispersion liquid 1: 169 parts
Specific resin particle dispersion liquid 1: 41 parts
Crystalline resin particle dispersion liquid: 53 parts
Release agent dispersion liquid: 25 parts
Colorant dispersion liquid: 33 parts
Anionic surfactant (“Dowfax2A1” produced by The Dow Chemical Company): 4.8 parts

After the liquid temperatures of above raw materials have been adjusted to 30° C., they are charged into a 3-liter cylindrical stainless steel container. The resulting mixture is stirred by performing dispersion for 2 minutes with a shearing force being applied using a homogenizer (ULTRA-TURRAX T50″ produced by IKA) at 4000 rpm.

Subsequently, 1.75 parts of a 10% nitric acid solution of aluminum sulfate is gradually added dropwise to the mixture as a coagulant. Then, stirring is performed by performing dispersion for 3 minutes with the rotation speed of the homogenizer being 4000 rpm. Hereby, a raw material dispersion liquid is prepared.

Subsequently, the raw material dispersion liquid is transferred to a polymerization vessel equipped with a stirring device having a twin paddle stirring impeller and a thermometer. Heating is started using a heating mantle with a stirrer rotation speed being 550 rpm. The growth of the aggregated particles is promoted at 40° C. In this step, the pH of the raw material dispersion liquid is controlled to fall within the range of 2.2 to 3.5 using a 0.3-M aqueous nitric acid solution and a 1-M aqueous sodium hydroxide solution. Holding is performed about 2 hours within the above pH range to form aggregated particles.

Subsequently, 42 parts of the amorphous resin particle dispersion liquid 1 is further added. Then, holding is performed for 60 minutes to cause the binder resin particles to adhere onto the surfaces of the aggregated particles.

The aggregated particles are adjusted while the sizes and forms of the particles are confirmed with an optical microscope and MULTISIZER 3.

Subsequently, pH is adjusted to 7.8 using a 5% aqueous sodium hydroxide solution, and holding is performed for 15 minutes. Then, pH is increased to 8.0 and the temperature is increased to 85° C. in order to cause fusion of the aggregated particles. At two hours after the fusion of the aggregated particles has been confirmed with an optical microscope, heating is stopped and cooling is performed at a cooling rate of 1.0° C./min. Subsequently, screening is performed through a 20-μm mesh, washing with water is repeatedly performed, and then drying is performed with a vacuum dryer. Hereby, toner particles C4 are prepared.

With 100 parts of the toner particles, 0.7 parts of silica particles treated with a dimethyl silicone oil (“RY200” produced by Nippon Aerosil Co., Ltd.) are mixed using a Henschel mixer. Hereby, a toner C4 is prepared.

### Comparative Example C5

Amorphous resin particle dispersion liquid 1: 169 parts
Crystalline resin particle dispersion liquid: 53 parts
Release agent dispersion liquid: 25 parts
Colorant dispersion liquid: 33 parts
Anionic surfactant (“Dowfax2A1” produced by The Dow Chemical Company): 4.8 parts

After the liquid temperatures of above raw materials have been adjusted to 30° C., they are charged into a 3-liter cylindrical stainless steel container. The resulting mixture is stirred by performing dispersion for 2 minutes with a shearing force being applied using a homogenizer (ULTRA-TURRAX T50″ produced by IKA) at 4000 rpm.

Subsequently, 1.75 parts of a 10% nitric acid solution of aluminum sulfate is gradually added dropwise to the mixture as a coagulant. Then, stirring is performed by performing dispersion for 3 minutes with the rotation speed of the homogenizer being 4000 rpm. Hereby, a raw material dispersion liquid is prepared.

Subsequently, the raw material dispersion liquid is transferred to a polymerization vessel equipped with a stirring device having a twin paddle stirring impeller and a thermometer. Heating is started using a heating mantle with a stirrer rotation speed being 550 rpm. The growth of the aggregated particles is promoted at 40° C. In this step, the pH of the raw material dispersion liquid is controlled to fall within the range of 2.2 to 3.5 using a 0.3-M aqueous nitric acid solution and a 1-M aqueous sodium hydroxide solution. Holding is performed about 2 hours within the above pH range to form aggregated particles.

Subsequently, a dispersion liquid prepared by mixing 42 parts of the amorphous resin particle dispersion liquid 1 with 41 parts of the specific resin particle dispersion liquid 1 is halved and further added in two batches. Then, holding is performed for 60 minutes to cause the binder resin particles and the specific resin particles to adhere onto the surfaces of the aggregated particles.

The aggregated particles are adjusted while the sizes and forms of the particles are confirmed with an optical microscope and MULTISIZER 3.

Subsequently, pH is adjusted to 7.8 using a 5% aqueous sodium hydroxide solution, and holding is performed for 15 minutes. Then, pH is increased to 8.0 and the temperature is increased to 85° C. in order to cause fusion of the aggregated particles. At two hours after the fusion of the aggregated particles has been confirmed with an optical microscope, heating is stopped and cooling is performed at a cooling rate of 1.0° C./min. Subsequently, screening is performed through a 20 μm mesh, washing with water is repeatedly performed, and then drying is performed with a vacuum dryer. Hereby, toner particles C5 are prepared.

With 100 parts of the toner particles, 0.7 parts of silica particles treated with a dimethyl silicone oil (“RY200” produced by Nippon Aerosil Co., Ltd.) are mixed using a Henschel mixer. Hereby, a toner C5 is prepared.

### Comparative Example C6

A toner C6 is prepared as in the preparation of the toner 1, except that the specific resin particle dispersion liquid 1 is not added.

### Comparative Example C7

A toner C7 is prepared as in the preparation of the toner 1, except that the pH at which the fusion of the aggregated particles is performed is changed from 8.0 to 6.5, the temperature to which heating is performed is changed from 85° C. to 75° C., and 5.2 parts of the anionic surfactant (“Dowfax2A1” produced by The Dow Chemical Company) is added when the temperature reaches 75° C.

### Comparative Example C8

A toner C8 is prepared as in the preparation of the toner 1, except that the pH at which the fusion of the aggregated particles is performed is changed from 8.0 to 10.0, and the temperature to which heating is performed is changed from 85° C. to 95° C.

Table 3 lists the type of the specific resin particle dispersion liquid or comparative resin particle dispersion liquid included in each of the toners (in Table 3, “Type of particles”), the content of the specific resin particles or comparative resin particles relative to the total amount of the entire toner particles (in Table 3, “Content (%) of particles”), the content of the crystalline resin relative to the total amount of the entire binder resin (in Table 3, “Crystalline resin content (%)”), and the type of the amorphous resin particle dispersion liquid (in Table 3, “Type of amorphous resin”).

Table 3 also lists the ratio of the content of the crystalline resin to the content of the specific resin particles in each of the toners (in Table 3, “Crystalline proportion vs particles”) and the ratio of the content of the amorphous resin to the content of the specific resin particles in each of the toners (in Table 3, “Amorphous proportion vs particles”).

Table 3 also lists the volume average size of the toner particles included in each of the toners.

Tables 4 and 5 list the storage modulus G′ of the remaining component at 30° C. or more and 50° C. or less (in Tables 4 and 5, “30-50° C. G′(Pa)”), the specific elasticity achieving temperature of the remaining component (in Tables 4 and 5, “Achieving temperature (° C.)”), and the loss tangent tan δ at the specific elasticity achieving temperature (in Tables 4 and 5, “Achieving temperature tan δ”), which are determined by the above-described methods.

Tables 4 and 5 also list D1(90), D50(90), D1(150), D50(150), D50(150)−D1(150) (in Tables 4 and 5, “Difference (150)”), D50(90)−D1(90) (in Tables 4 and 5, “Difference (90)”), the number average molecular weight of the THF soluble component of the toner particles (in Tables 4 and 5, “Mn”), the storage modulus G′ at 30° C. or more and 50° C. or less (in Tables 4 and 5, “30-50G′(Pa)”), the specific elasticity achieving temperature (in Tables 4 and 5, “Achieving temperature (° C.)”), log G′(t90-150)−log G′(r90-150) (in Tables 4 and 5, “Viscoelasticity difference”), and the difference (SP (S)−SP (R)) (in Tables 4 and 5, “SP difference”) of each of the toners, which are determined by the above-described methods.

Preparation of Developers

With 8 parts of each of the toners, 100 parts of the carrier described below is mixed to prepare a developer.

Preparation of Carrier
Ferrite particles (average size: 50 μm): 100 parts
Toluene: 14 parts
Styrene-methyl methacrylate copolymer (copolymerization ratio: 15/85): 3 parts
Carbon black: 0.2 parts

The above components other than the ferrite particles are dispersed with a sand mill to form a dispersion liquid. The dispersion liquid and the ferrite particles are charged into a degassing vacuum kneader. Then, while stirring is performed, the pressure is reduced and drying is performed. Hereby, a carrier is prepared.

Evaluations

Difference in Glossiness

One of the developers is charged into a developing device of a color copier ApeosPortlV C3370 (produced by FUJIFILM Business Innovation Corp.) from which a fuser has been removed. An unfixed image is formed at a toner deposition density of 0.45 mg/cm′. The recording medium used is OS coat W paper A4 size (basis weight: 127 gsm) produced by FUJIFILM Business Innovation Corp. The image has a size of 50 mm×50 mm and an area coverage of 100%.

The device used for fixation evaluation is a fuser removed from ApeosPortlV C3370 (produced by FUJIFILM Business Innovation Corp.) and modified such that the nip pressure and the fixing temperature can be changed. The processing speed is 175 mm/sec.

Under the above conditions, the unfixed image is fixed under the following two conditions to form fixed images: a low-temperature, low-pressure condition (specifically, fuser temperature: 120° C., and nip pressure: 1.6 kgf/cm²) and a high-temperature, high-pressure condition (specifically, fuser temperature: 180° C., and nip pressure: 6.0 kgf/cm²). The glossiness of each of the fixed image portions is measured by 60°-gloss with a glossmeter “Micro-TRI-Gross” produced by BYK, and the difference in glossiness between the image fixed under the high-temperature, high-pressure condition and the image fixed under the low-temperature, low-pressure condition (i.e., the difference in glossiness by condition) is determined. Tables 4 and 5 list the results.

When the difference in glossiness is less than 5, it is difficult to visually identify the difference in glossiness. When the difference in glossiness is 5 or more and less than 10, the difference in glossiness can be visually identified but is negligible. When the difference in glossiness is 10 or more and less than 15, the difference in glossiness can be visually confirmed but is within an acceptable range. When the difference in glossiness is 15 or more, the difference in glossiness is large and outside the acceptable range.

Fixability

The fixed image formed under the low-temperature, low-pressure condition in the evaluation of the difference in glossiness is folded using a weight. The portion of the image is inspected for the degree of missing of image in order to evaluate image quality. The evaluation standard used is as follows. Tables 4 and 5 list the results.
G1: Image missing is not confirmed.
G2: Image missing is confirmed but is negligible.
G3: Image missing is confirmed slightly but is within an acceptable range.
G4: Image missing is confirmed.

TABLE 3

| | | | | | | | | Toner |
|---|---|---|---|---|---|---|---|---|
| | | | | Crystalline | | | | particle size |
| Example/ | | Particles | | resin | Amorphous | Crystalline | Amorphous | volume |
| Comparative | | | Content | content | resin | proportion | proportion | average size |
| Example | Toner | Type | (%) | (%) | Type | vs particles | vs particles | (μm) |
| 1 | 1 | 1 | 10 | 15 | 1 | 1.35 | 7.65 | 5.3 |
| 2 | 2 | 2 | 10 | 15 | 1 | 1.35 | 7.65 | 4.5 |
| 3 | 3 | 3 | 10 | 15 | 1 | 1.35 | 7.65 | 4.3 |
| 4 | 4 | 4 | 10 | 15 | 1 | 1.35 | 7.65 | 5.6 |
| 5 | 5 | 5 | 10 | 15 | 1 | 1.35 | 7.65 | 4.2 |
| 6 | 6 | 6 | 10 | 15 | 1 | 1.35 | 7.65 | 4.4 |
| 7 | 7 | 7 | 10 | 15 | 1 | 1.35 | 7.65 | 4.5 |
| 8 | 8 | 8 | 10 | 15 | 1 | 1.35 | 7.65 | 4.7 |
| 9 | 9 | 9 | 10 | 15 | 1 | 1.35 | 7.65 | 4.4 |
| 10 | 10 | 1 | 29 | 15 | 1 | 0.37 | 2.08 | 4.8 |
| 11 | 11 | 1 | 2 | 15 | 1 | 7.35 | 41.65 | 4.2 |
| 12 | 12 | 1 | 4 | 49 | 1 | 11.76 | 12.24 | 4.5 |
| 13 | 13 | 1 | 10 | 4 | 1 | 0.36 | 8.64 | 4.5 |
| 14 | 14 | 10 | 10 | 0 | 1 | 0.00 | 9.00 | 4.4 |
| 15 | 15 | 1 | 10 | 10 | 2 | 1.35 | 7.65 | 5.1 |
| 16 | 16 | 1 | 10 | 15 | 1 | 1.35 | 7.65 | 4.9 |
| 17 | 17 | 1 | 10 | 5 | 1 | 0.45 | 8.55 | 5.1 |
| 18 | 18 | 1 | 15 | 23 | 1 | 1.30 | 4.36 | 5.5 |
| 19 | 19 | 1 | 10 | 15 | 1 | 1.35 | 7.65 | 4.9 |
| 20 | 20 | 1 | 10 | 15 | 1 | 1.35 | 7.65 | 4.5 |
| 21 | 21 | 1 | 3 | 15 | 1 | 4.85 | 27.48 | 4.3 |
| 22 | 22 | 1 | 19 | 15 | 1 | 0.64 | 3.62 | 4.7 |
| 23 | 23 | 3 | 5 | 25 | 1 | 4.75 | 14.25 | 4.4 |
| C1 | C1 | C1 | 10 | 15 | 1 | 1.35 | 7.65 | 4.3 |
| C2 | C2 | C2 | 10 | 15 | 1 | 1.35 | 7.65 | 4.2 |
| C3 | C3 | 1 | 10 | 15 | 1 | 1.35 | 7.65 | 4.8 |
| C4 | C4 | 1 | 10 | 15 | 1 | 1.35 | 7.65 | 4.3 |
| C5 | C5 | 1 | 10 | 15 | 1 | 1.35 | 7.65 | 4.6 |
| C6 | C6 | — | 0 | 15 | 1 | — | — | 4.9 |
| C7 | C7 | 1 | 10 | 15 | 1 | 1.35 | 7.65 | 5.0 |
| C8 | C8 | 1 | 10 | 15 | 1 | 1.35 | 7.65 | 4.5 |
| 24 | 24 | 1 | 1 | 15 | 1 | 14.85 | 84.15 | 4.8 |
| 25 | 25 | 1 | 31 | 15 | 1 | 0.33 | 1.89 | 4.7 |
| 26 | 26 | 2 | 10 | 4 | 1 | 0.36 | 8.64 | 4.7 |
| 27 | 27 | 10 | 10 | 49 | 1 | 4.41 | 4.59 | 4.8 |
| 28 | 28 | 1 | 10 | 15 | 3 | 1.35 | 7.65 | 4.7 |
| 29 | 29 | 11 | 10 | 15 | 1 | 1.35 | 7.65 | 4.4 |
| 30 | 30 | 12 | 10 | 15 | 1 | 1.35 | 7.65 | 4.4 |
| 31 | 31 | 13 | 10 | 15 | 1 | 1.35 | 7.65 | 4.8 |
| 32 | 32 | 14 | 10 | 15 | 1 | 1.35 | 7.65 | 4.5 |

TABLE 4

| Example/ | Remaining component | | | Toner | | | | |
|---|---|---|---|---|---|---|---|---|
| Com- | | Achieving | Achieving | | | | | Dif- |
| parative | 30-50° C. G′ | temperature | temperature | D1 | D50 | D1 | D50 | ference |
| Example | (Pa) | (° C.) | tanδ | (90) | (90) | (150) | (150) | (150) |
| 1 | 3.0 × 10⁸-5.3 × 10⁸ | 72 | 1.4 | 1.21 | 1.42 | 0.6 | 1.53 | 0.93 |
| 2 | 3.0 × 10⁸-5.3 × 10⁸ | 72 | 1.4 | 1.35 | 1.51 | 0.63 | 1.59 | 0.96 |
| 3 | 3.0 × 10⁸-5.3 × 10⁸ | 72 | 1.4 | 1.26 | 1.42 | 0.59 | 1.62 | 1.03 |
| 1 | 3.0 × 10⁸-5.3 × 10⁸ | 72 | 1.4 | 1.28 | 1.47 | 0.6 | 1.59 | 0.99 |
| 5 | 3.0 × 10⁸-5.3 × 10⁸ | 72 | 1.4 | 1.33 | 1.4 | 0.58 | 1.45 | 0.87 |
| 6 | 3.0 × 10⁸-5.3 × 10⁸ | 72 | 1.4 | 1.27 | 1.5 | 0.53 | 1.6 | 1.07 |
| 7 | 3.0 × 10⁸-5.3 × 10⁸ | 72 | 1.4 | 1.32 | 1.48 | 0.65 | 1.57 | 0.92 |
| 8 | 3.0 × 10⁸-5.3 × 10⁸ | 72 | 1.4 | 1.3 | 1.46 | 0.63 | 1.61 | 0.98 |
| 9 | 3.0 × 10⁸-5.3 × 10⁸ | 72 | 1.4 | 1.26 | 1.47 | 0.6 | 1.55 | 0.95 |
| 10 | 3.0 × 10⁸-5.3 × 10⁸ | 72 | 1.4 | 1.27 | 1.35 | 0.52 | 1.43 | 0.91 |
| 11 | 3.0 × 10⁸-5.3 × 10⁸ | 72 | 1.4 | 1.21 | 2.12 | 0.87 | 1.95 | 1.08 |
| 12 | 9.1 × 10⁷-2.3 × 10⁸ | 69 | 1.52 | 1.47 | 1.61 | 0.79 | 1.87 | 1.08 |
| 13 | 3.8 × 10⁸-6.0 × 10⁸ | 77 | 1.21 | 1.26 | 1.45 | 0.65 | 1.61 | 0.96 |
| 14 | 5.5 × 10⁸-7.0 × 10⁸ | 86 | 1.55 | 1.31 | 1.47 | 0.67 | 1.52 | 0.85 |
| 15 | 4.3 × 10⁸-6.1 × 10⁸ | 81 | 1.51 | 1.24 | 1.47 | 0.63 | 1.55 | 0.92 |
| 16 | 3.0 × 10⁸-5.3 × 10⁸ | 72 | 1.4 | 1.22 | 1.44 | 0.58 | 1.81 | 1.23 |
| 17 | 3.7 × 10⁸-5.9 × 10⁸ | 90 | 1.24 | 1.25 | 1.46 | 0.58 | 1.51 | 0.93 |
| 18 | 1.2 × 10⁸-4.5 × 10⁸ | 68 | 1.43 | 1.22 | 1.39 | 0.56 | 1.59 | 1.03 |
| 19 | 3.0 × 10⁸-5.3 × 10⁸ | 71 | 1.57 | 1.27 | 1.53 | 0.53 | 1.57 | 1.04 |
| 20 | 3.0 × 10⁸-5.3 × 10⁸ | 76 | 0.85 | 1.31 | 1.49 | 0.57 | 1.53 | 0.96 |
| | | Toner | | | | | | |
| Com- | | | | Achieving | Visco- | | Evaluations | |
| parative | Difference | | 30-50° C. G′ | temperature | elasticity | SP | Gloss | Fix- |
| Example | (90) | Mn | (Pa) | (° C.) | difference | difference | difference | ability |
| 1 | 0.21 | 8891 | 2.5 × 10⁸-4.8 × 10⁸ | 82 | 3.3 | −0.26 | 4.8 | G1 |
| 2 | 0.16 | 8351 | 2.7 × 10⁸-5.3 × 10⁸ | 85 | 3.2 | −0.26 | 7.5 | G3 |
| 3 | 0.16 | 8931 | 2.2 × 10⁸-4.5 × 10⁸ | 80 | 3.5 | −0.26 | 11.8 | G2 |
| 1 | 0.19 | 9021 | 2.5 × 10⁸-4.8 × 10⁸ | 82 | 3.3 | −0.28 | 8.2 | G2 |
| 5 | 0.07 | 10751 | 2.5 × 10⁸-4.8 × 10⁸ | 82 | 3.7 | −0.28 | 6.4 | G3 |
| 6 | 0.23 | 7370 | 2.5 × 10⁸-4.8 × 10⁸ | 82 | 3.4 | −0.28 | 7.7 | G2 |
| 7 | 0.16 | 9511 | 2.5 × 10⁸-4.8 × 10⁸ | 83 | 3.2 | −0.28 | 6.2 | G3 |
| 8 | 0.16 | 9617 | 2.5 × 10⁸-4.8 × 10⁸ | 83 | 3.5 | −0.28 | 13.4 | G2 |
| 9 | 0.21 | 7404 | 2.5 × 10⁸-4.8 × 10⁸ | 82 | 3.3 | −0.28 | 7.1 | G3 |
| 10 | 0.08 | 8436 | 1.5 × 10⁸-4.3 × 10⁸ | 88 | 2.5 | −0.26 | 7.4 | G2 |
| 11 | 0.91 | 11166 | 2.9 × 10⁸-5.2 × 10⁸ | 80 | 3.8 | −0.26 | 9.1 | G1 |
| 12 | 0.14 | 8192 | 1.3 × 10⁸-4.2 × 10⁸ | 74 | 3.7 | −0.13 | 11.1 | G1 |
| 13 | 0.19 | 9224 | 3.2 × 10⁸-6.1 × 10⁸ | 88 | 3.1 | −0.30 | 7.4 | G3 |
| 14 | 0.16 | 9683 | 4.5 × 10⁸-6.8 × 10⁸ | 89 | 1.5 | −0.28 | 7.8 | G3 |
| 15 | 0.23 | 8942 | 3.1 × 10⁸-4.8 × 10⁸ | 87 | 2.2 | −0.18 | 7.4 | G3 |
| 16 | 0.22 | 9834 | 2.5 × 10⁸-4.8 × 10⁸ | 83 | 3.1 | −0.26 | 12.1 | G2 |
| 17 | 0.21 | 8805 | 2.7 × 10⁸-5.0 × 10⁸ | 90 | 2.6 | −0.30 | 8.3 | G3 |
| 18 | 0.17 | 7608 | 8.5 × 10⁷-3.2 × 10⁸ | 79 | 2.9 | −0.23 | 12.5 | G2 |
| 19 | 0.26 | 7786 | 2.1 × 10⁸-4.6 × 10⁸ | 80 | 2.6 | −0.26 | 13.5 | G2 |
| 20 | 0.18 | 9421 | 2.4 × 10⁸-4.9 × 10⁸ | 87 | 3.8 | −0.26 | 12.1 | G2 |

TABLE 5

| Example/ | Remaining component | | | Toner | | | | |
|---|---|---|---|---|---|---|---|---|
| Com- | | Achieving | Achieving | | | | | Dif- |
| parative | 30-50° C. G′ | temperature | temperature | D1 | D50 | D1 | D50 | ference |
| Example | (Pa) | (° C.) | tanδ | (90) | (90) | (150) | (150) | (150) |
| 21 | 3.0 × 10⁸- | 71 | 1.51 | 1.35 | 1.63 | 0.91 | 2.39 | 1.48 |
| | 5.3 × 10⁸ | | | | | | | |
| 22 | 3.0 × 10⁸- | 75 | 0.92 | 0.55 | 0.74 | 0.63 | 1.53 | 0.9 |
| | 5.3 × 10⁸ | | | | | | | |
| 23 | 3.0 × 10⁸- | 72 | 1.4 | 1.35 | 1.65 | 0.51 | 1.98 | 1.47 |
| | 5.3 × 10⁸ | | | | | | | |
| C1 | 3.0 × 10⁸- | 72 | 1.4 | 1.25 | 1.44 | 0.58 | 2.45 | 1.67 |
| | 5.3 × 10⁸ | | | | | | | |
| C2 | 3.0 × 10⁸- | 72 | 1.4 | 1.24 | 1.84 | 0.63 | 2.25 | 1.62 |
| | 5.3 × 10⁸ | | | | | | | |
| C3 | 3.0 × 10⁸- | 72 | 1.4 | 1.18 | 1.38 | 0.59 | 2.14 | 1.55 |
| | 5.3 × 10⁸ | | | | | | | |
| C4 | 3.0 × 10⁸- | 72 | 1.4 | 1.18 | 2.23 | 0.63 | 2.27 | 1.64 |
| | 5.3 × 10⁸ | | | | | | | |
| C5 | 3.0 × 10⁸- | 72 | 1.4 | 1.19 | 1.64 | 0.52 | 2.21 | 1.69 |
| | 5.3 × 10⁸ | | | | | | | |
| C6 | 3.0 × 10⁸- | 72 | 1.4 | 1.26 | 2.2 | 0.91 | 2.25 | 1.34 |
| | 5.3 × 10⁸ | | | | | | | |
| C7 | 3.0 × 10⁸- | 72 | 1.4 | 1.31 | 1.62 | 0.67 | 1.94 | 1.27 |
| | 5.3 × 10⁸ | | | | | | | |
| C8 | 3.0 × 10⁸- | 72 | 1.4 | 1.29 | 1.59 | 0.59 | 2.08 | 1.49 |
| | 5.3 × 10⁸ | | | | | | | |
| 24 | 3.0 × 10⁸- | 72 | 1.4 | 1.52 | 1.83 | 0.61 | 1.96 | 1.35 |
| | 5.3 × 10⁸ | | | | | | | |
| 25 | 3.0 × 10⁸- | 72 | 1.4 | 1.24 | 1.64 | 0.87 | 1.95 | 1.08 |
| | 5.3 × 10⁸ | | | | | | | |
| 26 | 3.0 × 10⁸- | 72 | 1.4 | 1.29 | 1.43 | 0.62 | 1.62 | 1 |
| | 5.3 × 10⁸ | | | | | | | |
| 27 | 3.0 × 10⁸- | 72 | 1.4 | 1.42 | 1.59 | 0.75 | 1.83 | 1.08 |
| | 5.3 × 10⁸ | | | | | | | |
| 28 | 3.4 × 10⁸- | 71 | 1.42 | 1.22 | 1.54 | 0.64 | 1.67 | 1.03 |
| | 5.5 × 10⁸ | | | | | | | |
| 29 | 3.0 × 10⁸- | 72 | 1.4 | 1.32 | 1.56 | 0.75 | 1.89 | 1.14 |
| | 5.3 × 10⁸ | | | | | | | |
| 30 | 3.0 × 10⁸- | 72 | 1.4 | 1.46 | 1.67 | 0.79 | 2.01 | 1.22 |
| | 5.3 × 10⁸ | | | | | | | |
| 31 | 3.0 × 10⁸- | 72 | 1.4 | 1.21 | 1.41 | 0.51 | 1.98 | 1.47 |
| | 5.3 × 10⁸ | | | | | | | |
| 32 | 3.0 × 10⁸- | 72 | 1.4 | 1.35 | 1.57 | 0.76 | 2.23 | 1.47 |
| | 5.3 × 10⁸ | | | | | | | |
| Example/ | Toner | | | | | | | |
| Com- | | | | Achieving | Visco- | SP | Evaluations | |
| parative | Difference | | 30-50° C. G′ | temperature | elasticity | dif- | Gloss | Fix- |
| Example | (90) | Mn | (Pa) | (° C.) | difference | ference | difference | ability |
| 21 | 0.28 | 9207 | 2.8 × 10⁸- | 78 | 2.4 | −0.26 | 12.5 | G2 |
| | | | 5.2 × 10⁸ | | | | | |
| 22 | 0.19 | 7815 | 2.2 × 10⁸- | 84 | 3.7 | −0.26 | 8.1 | G3 |
| | | | 4.5 × 10⁸ | | | | | |
| 23 | 0.3 | 7780 | 1.8 × 10⁸- | 78 | 3.2 | −0.24 | 13.6 | G1 |
| | | | 4.4 × 10⁸ | | | | | |
| C1 | 0.19 | 7400 | 2.5 × 10⁸- | 90 | 2.9 | −0.25 | 21.9 | G4 |
| | | | 7.6 × 10⁸ | | | | | |
| C2 | 0.6 | 7892 | 1.2 × 10⁸- | 72 | 2.5 | −0.26 | 23.4 | G2 |
| | | | 3.6 × 10⁸ | | | | | |
| C3 | 0.2 | 8858 | 2.6 × 10⁸- | 82 | 3.4 | −0.26 | 25.1 | G3 |
| | | | 4.7 × 10⁸ | | | | | |
| C4 | 1.05 | 8209 | 2.9 × 10⁸- | 83 | 3.1 | −0.26 | 23.9 | G2 |
| | | | 5.1 × 10⁸ | | | | | |
| C5 | 0.45 | 8429 | 2.1 × 10⁸- | 83 | 3.2 | −0.26 | 24.2 | G4 |
| | | | 4.3 × 10⁸ | | | | | |
| C6 | 0.94 | 9015 | 3.0 × 10⁸- | 72 | — | — | 25.1 | G2 |
| | | | 5.3 × 10⁸ | | | | | |
| C7 | 0.31 | 16892 | 2.9 × 10⁸- | 86 | 3.2 | −0.26 | 10.8 | G4 |
| | | | 5.1 × 10⁸ | | | | | |
| C8 | 0.3 | 4239 | 2.4 × 10⁸- | 81 | 3.2 | −0.26 | 23.1 | G3 |
| | | | 4.4 × 10⁸ | | | | | |
| 24 | 0.31 | 7624 | 2.9 × 10⁸- | 81 | 3.7 | −0.26 | 14.2 | G1 |
| | | | 5.4 × 10⁸ | | | | | |
| 25 | 0.4 | 9673 | 2.9 × 10⁸- | 80 | 3.8 | −0.26 | 6.4 | G4 |
| | | | 5.2 × 10⁸ | | | | | |
| 26 | 0.14 | 7743 | 3.4 × 10⁸- | 89 | 3.2 | −0.32 | 13.8 | G2 |
| | | | 6.0 × 10⁸ | | | | | |
| 27 | 0.17 | 8596 | 1.3 × 10⁸- | 75 | 3.6 | −0.09 | 13.6 | G1 |
| | | | 4.3 × 10⁸ | | | | | |
| 28 | 0.32 | 9201 | 2.9 × 10⁸- | 81 | 3.4 | −0.22 | 11.6 | G2 |
| | | | 5.1 × 10⁸ | | | | | |
| 29 | 0.24 | 8657 | 2.7 × 10⁸- | 82 | 3.2 | −0.26 | 9.5 | G2 |
| | | | 5.0 × 10⁸ | | | | | |
| 30 | 0.21 | 9524 | 2.7 × 10⁸- | 80 | 3.0 | −0.26 | 11.1 | G2 |
| | | | 5.1 × 10⁸ | | | | | |
| 31 | 0.2 | 7923 | 3.1 × 10⁸- | 85 | 3.7 | −0.26 | 12.1 | G4 |
| | | | 5.0 × 10⁸ | | | | | |
| 32 | 0.22 | 10262 | 2.0 × 10⁸- | 80 | 2.9 | −0.26 | 24.7 | G2 |
| | | | 4.8 × 10⁸ | | | | | |

The above results confirm that the toners prepared in Examples enable suitable fixability to be achieved and reduce the difference in glossiness between an image fixed under a high-temperature, high-pressure condition and an image fixed under a low-temperature, low-pressure condition.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An electrostatic image developing toner comprising toner particles including a binder resin,
wherein, when loss tangents tan δ at a temperature of 90° C. and a strain of 1%, a temperature of 90° C. and a strain of 50%, a temperature of 150° C. and a strain of 1%, and a temperature of 150° C. and a strain of 50%, the loss tangents tan δ being determined by measurement of dynamic viscoelasticity of the electrostatic image developing toner, are defined as D1(90), D50(90), D1(150), and D50(150), respectively,
D1(90), D50(90), D1(150), and D50(150) are each 0.5 or more and 2.5 or less,
D50(150)−D1(150) is less than 1.5, and
D50(90)−D1(90) is less than 1.0;
the toner particles further include resin particles; and
a number average molecular weight of a component of the toner particles, the component being soluble in tetrahydrofuran, is 5000 or more and 15000 or less.

2. The electrostatic image developing toner according to claim 1, wherein a glass transition temperature Tg determined by measurement of dynamic viscoelasticity of the resin particles is 10° C. or more and 45° C. or less.

3. The electrostatic image developing toner according to claim 1, wherein a loss tangent tan δ at 30° C. or more and 150° C. or less, the loss tangent tan δ being determined by measurement of dynamic viscoelasticity of the resin particles at a heating rate of 2° C./min, is 0.01 or more and 2.5 or less.

4. The electrostatic image developing toner according to claim 1, wherein a number average size of the resin particles is 60 nm or more and 300 nm or less.

5. The electrostatic image developing toner according to claim 1, wherein a content of the resin particles is 2% by mass or more and 30% by mass or less of a total amount of the toner particles.

6. The electrostatic image developing toner according to claim 1, wherein the resin particles are crosslinked resin particles.

7. The electrostatic image developing toner according to claim 6, wherein the crosslinked resin particles are styrene (meth)acrylic resin particles.

8. The electrostatic image developing toner according to claim 1, wherein a difference (SP (S)−SP (R)) between a solubility parameter SP (S) of the resin particles and a solubility parameter SP (R) of the binder resin is −0.32 or more and −0.12 or less.

9. The electrostatic image developing toner according to claim 1, wherein a storage modulus G′ at 30° C. or more and 50° C. or less, the storage modulus G′ being determined by measurement of dynamic viscoelasticity of a component at a heating rate of 2° C./min, the component remaining after the resin particles have been removed from the toner particles, is 1×10⁸ Pa or more, and a temperature at which the storage modulus G′ reaches less than 1×10⁵ Pa is 65° C. or more and 90° C. or less.

10. The electrostatic image developing toner according to claim 9, wherein a loss tangent tan δ at the temperature at which the storage modulus G′ reaches less than 1×10⁵ Pa, the loss tangent tan δ being determined by measurement of dynamic viscoelasticity of a component at a heating rate of 2° C./min, the component remaining after the resin particles have been removed from the toner particles, is 0.8 or more and 1.6 or less.

11. The electrostatic image developing toner according to claim 1,
wherein, when a storage modulus of the resin particles at 90° C. or more and 150° C. or less, a storage modulus of the toner particles at 90° C. or more and 150° C. or less, and a storage modulus of a component at 90° C. or more and 150° C. or less, the component remaining after the resin particles have been removed from the toner particles, the storage moduli being determined by measurement of dynamic viscoelasticity at a heating rate of 2° C./min, are defined as G′(p90-150), G′(t90-150), and G′(r90-150), respectively,
1×10⁴ Pa≤G′(p90-150)<1×10⁶ Pa, and
1.0≤log G′(t90-150)−log G′(r90-150)<4.0.

12. The electrostatic image developing toner according to claim 1, wherein a storage modulus G′ at 30° C. or more and 50° C. or less, the storage modulus G′ being determined by measurement of dynamic viscoelasticity of the electrostatic image developing toner at a heating rate of 2° C./min, is 1×10⁸ Pa or more, and a temperature at which the storage modulus G′ reaches less than 1×10⁵ Pa is 65° C. or more and 90° C. or less.

13. The electrostatic image developing toner according to claim 1,
wherein the binder resin includes a crystalline resin, and
a content of the crystalline resin is 4% by mass or more and 50% by mass or less of a total amount of the binder resin.

14. The electrostatic image developing toner according to claim 1, wherein the binder resin includes a polyester resin.

15. The electrostatic image developing toner according to claim 14, wherein the binder resin includes an amorphous polyester resin having an aliphatic dicarboxylic acid unit and a crystalline polyester resin having an aliphatic dicarboxylic acid unit.

16. The electrostatic image developing toner according to claim 1, wherein the resin particles include a difunctional alkyl acrylate as a structural unit, and the number of carbon atoms included in an alkylene chain included in the difunctional alkyl acrylate is 6 or more.

17. The electrostatic image developing toner according to claim 1,
wherein a glass transition temperature Tg determined by measurement of dynamic viscoelasticity of the resin particles is 10° C. or more and 45° C. or less,
a loss tangent tan δ at 30° C. or more and 150° C. or less, the loss tangent tan δ being determined by measurement of dynamic viscoelasticity of the resin particles at a heating rate of 2° C./min, is 0.01 or more and 2.5 or less,
the resin particles are crosslinked resin particles, and
a storage modulus G′ at 30° C. or more and 50° C. or less, the storage modulus G′ being determined by measurement of dynamic viscoelasticity of the electrostatic image developing toner at a heating rate of 2° C./min, is 1×10⁸ Pa or more, and a temperature at which the storage modulus G′ reaches less than 1×10⁵ Pa is 65° C. or more and 90° C. or less.

18. The electrostatic image developing toner according to claim 1,
wherein a glass transition temperature Tg determined by measurement of dynamic viscoelasticity of the resin particles is 10° C. or more and 45° C. or less,
a loss tangent tan δ at 30° C. or more and 150° C. or less, the loss tangent tan δ being determined by measurement of dynamic viscoelasticity of the resin particles at a heating rate of 2° C./min, is 0.01 or more and 2.5 or less,
the resin particles are crosslinked resin particles,
the crosslinked resin particles are styrene (meth)acrylic resin particles, and the resin particles include a difunctional alkyl acrylate as a structural unit, and the number of carbon atoms included in an alkylene chain included in the difunctional alkyl acrylate is 6 or more.

19. A toner cartridge detachably attachable to an image forming apparatus, the toner cartridge comprising:
the electrostatic image developing toner according to claim 1.

20. An image forming apparatus comprising:
an image holding member;
a charging unit that charges a surface of the image holding member;
an electrostatic image formation unit that forms an electrostatic image on the charged surface of the image holding member;
a developing unit that includes an electrostatic image developer comprising the electrostatic image developing toner according to claim 1 and develops the electrostatic image formed on the surface of the image holding member with the electrostatic image developer to form a toner image;
a transfer unit that transfers the toner image formed on the surface of the image holding member onto a surface of a recording medium; and
a fixing unit that fixes the toner image transferred on the surface of the recording medium.
